(19) United States
(12) Patent Application Publication
(10) Pub. No.: US 2025/0251882 A1
(43) Pub. Date: Aug. 7, 2025

(54) INFORMATION PROCESSING APPARATUS, INFORMATION PROCESSING SYSTEM, AND INFORMATION PROCESSING METHOD

(71) Applicant: CANON KABUSHIKI KAISHA, Tokyo (JP)

(72) Inventor: KATSUYUKI MURAKAMI, Chiba (JP)

(21) Appl. No.: 19/043,915

(22) Filed: Feb. 3, 2025

(30) Foreign Application Priority Data
Feb. 5, 2024 (JP) 2024-015348

(51) Int. Cl. G06F 3/12; G06T 7/00

(52) U.S. Cl. CPC G06F 3/121; G06F 3/1259; G06T 7/001; G06T 2207/20212; G06T 2207/30144

(57) ABSTRACT

An object is to provide an information processing apparatus capable of checking inspected printed material and the inspection level of the inspected printed material. The information processing apparatus for creating an inspection report including a result of an inspection for the printed material includes an obtaining unit configured to obtain a scanned image of printed material, an inspection area set for the printed material, and an inspection level in the inspection area and an output unit configured to output a result of an inspection for the printed material along with the scanned image, the inspection area, and the inspection level.

### BACKGROUND

### Field of the Disclosure

The present disclosure relates to an information processing apparatus, an information processing system, and an information processing method.

### Description of the Related Art

There is a printing system (information processing system) incorporating an inspection apparatus (information processing apparatus) for inspecting whether or not there is an abnormality in printed material after a printing apparatus prints the printed material. In this type of printing system, Japanese Patent Laid-Open No. 2021-078082 has disclosed setting of an inspection area that is taken as the target of inspection and an inspection level for the inspection area.

### SUMMARY

With the inspection apparatus of Japanese Patent Laid-Open No. 2021-078082, it is difficult to check a set inspection level unless application software (in the following, called application) dedicated for inspection is used.

Consequently, an object of the present disclosure is to provide an information processing apparatus capable of checking inspected printed material and the inspection level thereof.

The information processing apparatus of the present disclosure includes: a memory that stores a program; and a processor that executes the program to perform: obtaining a scanned image of printed material, an inspection area set for the printed material, and an inspection level in the inspection area; and outputting a result of an inspection for the printed material along with the scanned image, the inspection area, and the inspection level.

Further features of the present disclosure will become apparent from the following description of exemplary embodiments with reference to the attached drawings.

### BRIEF DESCRIPTION OF THE DRAWINGS

FIG. 1 is a diagram showing one example of an information processing system in one embodiment;

FIG. 2 is a diagram showing an internal configuration of an image forming apparatus in one embodiment;

FIG. 3 is a diagram showing one example of a menu screen in one embodiment;

FIG. 4 is a flowchart showing setting processing of inspection in one embodiment;

FIG. 5 is a diagram showing one example of a setting screen in one embodiment;

FIG. 6 is a diagram showing one example of a report setting screen in one embodiment;

FIG. 7 is a sequence diagram showing a flow of entire print processing in one embodiment;

FIG. 8 is a flowchart showing a subroutine of inspection processing in one embodiment;

FIG. 9 is a flowchart showing a flow of processing in a case where an inspection report is created in one embodiment;

FIG. 10 is a diagram showing one example of “inspection report (summary)” in one embodiment;

FIG. 11 is a diagram showing one example of “inspection report (details)” in one embodiment;

FIG. 12A is a diagram showing one example of the third portion functioning as “inspection report (image)” of the printed material determined to have no abnormality.

FIG. 12B is a diagram showing one example of the third portion functioning as “inspection report (image)” in a case where a streak is detected in the important inspection area.

FIG. 12C is a diagram showing one example of a third portion functioning as “inspection report (image)” in a case where a spot-shaped defect is detected in the standard inspection area.

FIG. 12D is a diagram showing one example of a third portion functioning as “inspection report (image)” in a case where a collation mismatch is detected in the character string inspection area.

FIG. 13 is a diagram showing one example of a table in one embodiment;

FIG. 14 is a modification example of “inspection report (details)”; and

FIG. 15 is a diagram showing one example of an abnormality check screen in one embodiment.

### DESCRIPTION OF THE EMBODIMENTS

In the following, aspect for embodying the technique of the present disclosure is explained by using the drawings. However, components described in these embodiments are merely exemplary and not intended to limit the technical scope of the present disclosure to these.

### First Embodiment

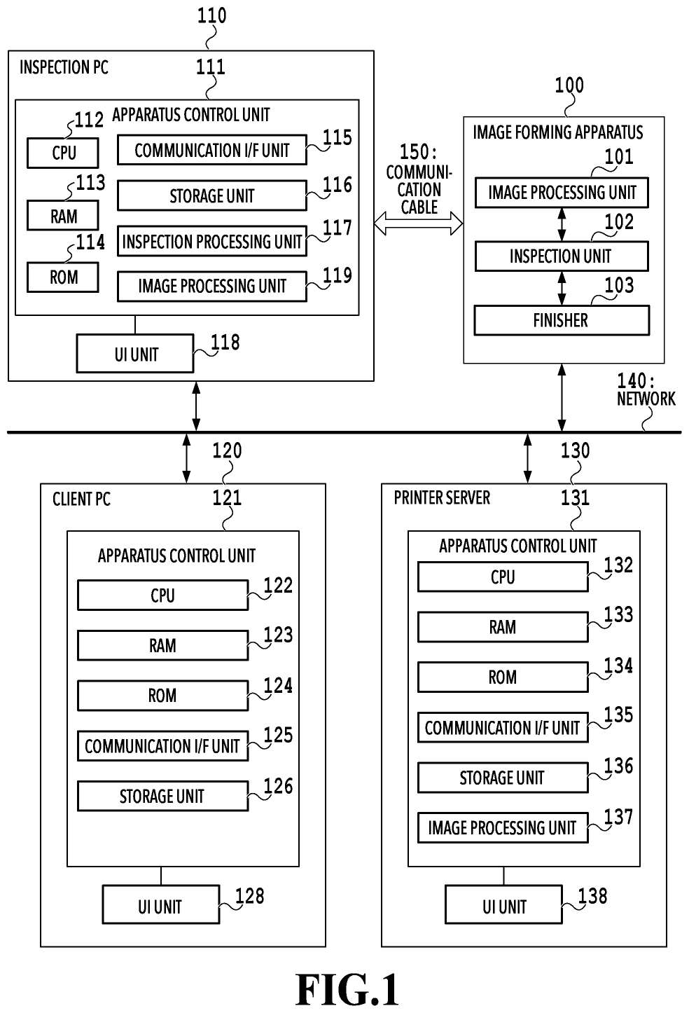

FIG. 1 is a diagram showing one example of an information processing system that can be applied to the present embodiment.

As shown in FIG. 1, this system includes an image forming apparatus 100 for forming an image on a sheet, an inspection PC 110 functioning as an information processing apparatus for creating an inspection report including inspection results of printed material, a client PC 120, and a printer server 130. The inspection PC 110, the client PC 120, and the printer server 130 are connected via a network 140. The inspection PC 110 and the image forming apparatus 100 are connected via the network 140 and a communication cable 150.

In the present embodiment, there is a case where the single inspection PC 110 is called “information processing apparatus” and a combination of the inspection PC 110 and an inspection unit 102 or a combination of the image forming apparatus 100 and the inspection PC 110 is called “information processing system.”

### <Image Forming Apparatus 100>

It is possible for the image forming apparatus 100 to perform printing based on various pieces of input data (for example, document data, written material data and the like sent from the client PC 120 and the printer server 130). The image forming apparatus 100 comprises an image processing unit 101, the inspection unit 102, and a finisher 103. The image processing unit 101, the inspection unit 102, and the finisher 103 are connected via a communication cable, which is an internal bus.

The image processing unit 101 performs, based on various kinds of input data, image processing in accordance with printing setting and outputs an image for which image processing has been performed as printed material printed on a sheet. The inspection unit 102 receives the printed material output from the image processing unit 101 and obtains a read image (scanned image) by reading the printed material by scanning it. This scanned image is used as image data for inspecting whether or not there is an abnormality in the printed material.

In the present embodiment, “abnormality” means an element that reduces the quality of printed material. For example, as the types of abnormality include a circular shape (spot-shaped defect) that occurs by a color material sticking to an unintended portion in printing, color void and a line (streak) that occurs by a sufficient color material not sticking to an intended portion.

A scanned image is transmitted from the image forming apparatus 100 to the inspection PC 110 via the communication cable 150. In the inspection PC 110, inspection of printed material is performed. Then, inspection results of the inspection are transmitted from the inspection PC 110 to the image forming apparatus 100. In the image forming apparatus 100, the inspection unit 102 obtains the inspection results transmitted from the inspection PC 110. The finisher 103 receives the printed material inspected in the inspection unit 102 and switches the discharge destinations based on the inspection results of the inspection PC 110, performs postprocessing (book binding and the like) as needed, and so on.

The image forming apparatus 100 is connected to the inspection PC 110, the client PC 120, and the printer server 130 via the network 140. Then, the image forming apparatus 100 is connected to the inspection PC 110 via the communication cable 150. The scanned image in a case of inspection, the inspection results and the like are transmitted and received via the communication cable 150. In the present embodiment, inspection is made in the inspection PC 110, but inspection may be made by an in-line inspector forming an image, making inspection, and performing postprocessing and discharge in an integrated manner.

It is possible for the inspection PC 110 to inspect printed material by analyzing a scanned image read from the printed material by using the inspection unit 102 of the image forming apparatus 100. The inspection PC 110 comprises an apparatus control unit 111 and a UI (User Interface) unit 118. The apparatus control unit 111 includes a controller substrate. On the controller substrate of the apparatus control unit 111, a CPU 112, a RAM 113, a ROM 114, a communication I/F unit 115, a storage unit 116, an inspection processing unit 117, and an image processing unit 119 are mounted. Communication between each module is performed by an internal system bus, not shown schematically.

The CPU 112 reads a main program from the storage unit 116 in accordance with an initial program within the storage unit 116 and stores the main program in the RAM 113. The RAM 113 is used as a program storage and a main memory for work. The ROM 114 is used for temporarily storing data created during processing of a program. The communication I/F unit 115 is used in a case where communication via the network 140 and the communication cable 150 is performed. The storage unit 116 is used for storing data, such as programs, and large-capacity data, such as scanned images.

In the present embodiment, “reference image” means a scanned image obtained by scanning printed material without abnormality.

The inspection processing unit 117 is used to calculate a difference value between the reference image stored in the RAM 113 and the scanned image of the inspection-target printed material for inspecting whether or not there is an abnormality in the printed material. The inspection processing unit 117 makes inspection by comparing the calculated difference value and an inspection threshold value (contrast, and size) of each inspection item for each pixel. Inspection results are stored in the RAM 113. In the RAM 113, for example, information indicating whether or not there is an abnormality in printed material, positional information in a case where the type of detected abnormality (spot-shaped defect, streak and the like) is displayed on the UI unit 118, and the like are stored. Inspection results are transmitted from the inspection PC 110 to the inspection unit 102 of the image forming apparatus 100 via the communication cable 150.

The image processing unit 119 of the inspection PC 110 performs image processing to convert a scanned image of printed material into a resolution optimum to inspection. The UI unit 118 is a device capable of inputting various setting values or designation values. The UI unit 118 includes, for example, a keyboard, mouse, display, another input/output device and the like.

In the present embodiment, the inspection PC 110 is connected with the image forming apparatus 100 via the communication cable 150. The inspection PC 110 may be included in the image forming apparatus 100. With the configuration such as this, it is possible to inspect printed material.

The client PC 120 is connected to the inspection PC 110 and the printer server 130. It may be possible for the client PC 120 to receive an operation by a user. The client PC 120 comprises an apparatus control unit 121 and a UI unit 128. The apparatus control unit 121 includes a controller substrate. On the controller substrate of the apparatus control unit 121, a CPU 122, a RAM 123, a ROM 124, a communication I/F unit 125, and a storage unit 126 are mounted. The role of each device inside the client PC 120 is the same as that of each device inside the inspection PC 110, and therefore, explanation is omitted.

It is possible for the printer server 130 to perform RIP processing for printing document data and written material data. The printer server 130 also performs control relating to printing of the image forming apparatus 100 and management of print jobs. The printer server 130 comprises an apparatus control unit 131 and a UI unit 138. The apparatus control unit 131 includes a controller substrate. On the controller substrate of the apparatus control unit 131, a CPU 132, a RAM 133, a ROM 134, a communication I/F unit 135, a storage unit 136, and an image processing unit 137 are mounted. The role of each device inside the printer server 130 is the same as the role of each device inside the client PC 120 except for the image processing unit 137, and therefore, explanation is omitted.

The image processing unit 137 performs RIP processing for printing the document data and written material data transmitted from the client PC 120 in accordance with the printing setting. In the RIP processing, the document data and written material data transmitted from the client PC 120 are converted into bitmap image data. Specifically, in the RIP processing, processing to generate an image without reducing a resolution of 600 dpi is performed.

It is possible for the image forming apparatus 100, the inspection PC 110, the client PC 120, and the printer server 130 to communicate with one another via the network 140. Then, each of these devices may be connected to another device via a network.

The above is the explanation of the information processing system that can be applied to the present embodiment.

### <Image Forming Apparatus 100>

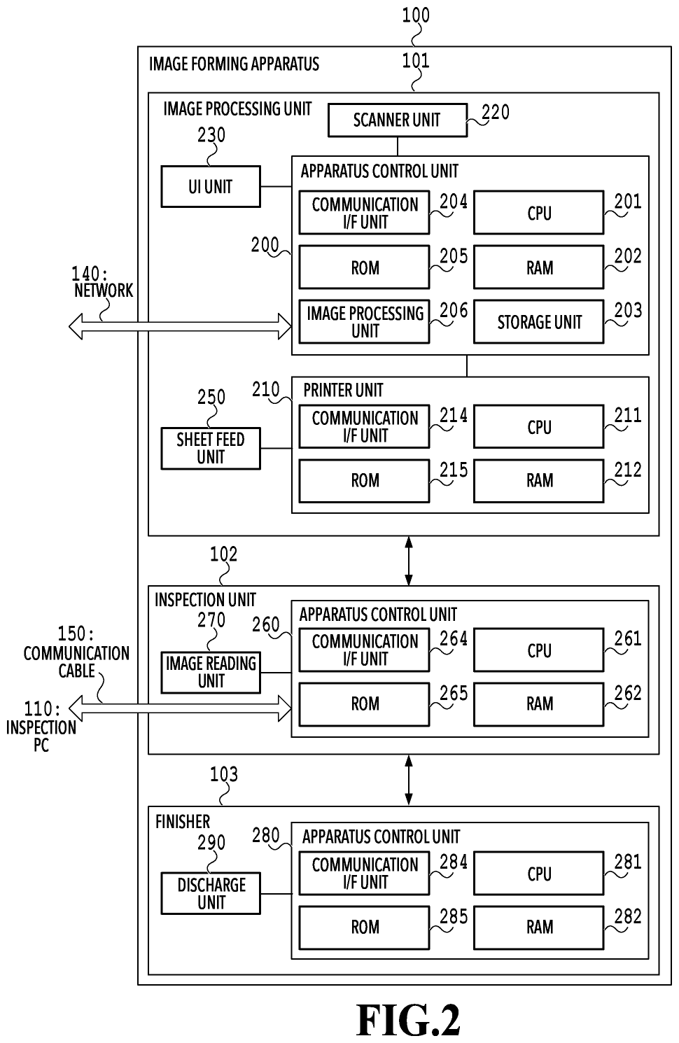

FIG. 2 is a diagram showing the internal configuration of the image forming apparatus 100 in the present embodiment.

As shown in FIG. 2, the image forming apparatus 100 comprises the image processing unit 101, the inspection unit 102, and the finisher 103. The image processing unit 101 comprises an apparatus control unit 200, a printer unit 210, a scanner unit 220, a UI unit 230, and a sheet feed unit 250. The apparatus control unit 200 receives printing-target document data and written material data from the network 140 and converts them into printing data. In the apparatus control unit 200, a CPU 201, a RAM 202, a storage unit 203, a communication I/F unit 204, a ROM 205, and an image processing unit 206 are mounted. The role of each of these devices is the same as the role of each device in the printer server 130, and therefore, explanation is omitted.

The image processing unit 206 obtains PDL data stored in the RAM 202 and performs image processing to convert the PDL data into printing data. The image processing to convert the PDL data into printing data means, for example, converting the PDL data into multi-valued bitmap data by performing RIP processing for the PDL data and converting the multi-valued bitmap data into binary bitmap data by performing pseudo halftone processing, such as screen processing.

The binary bitmap data obtained by the image processing unit 206 is transmitted to the printer unit 210 via the communication I/F unit 204. The printer unit 210 conveys a sheet (for example, printing sheet, coated paper, printing medium and the like) from the sheet feed unit 250, receives the binary bitmap data generated by the apparatus control unit 200, and performs printing for the sheet using color materials.

In this case, instructions based on the printing setting designated by a user are transmitted to the printer unit 210. For example, in a case of the printing setting using coated paper, the CPU 211 transmits instructions to perform printing by using a sheet cassette, not shown schematically, inside the sheet feed unit 250, in which coat paper is stored. By the various pieces of processing from the above-described reception of PDL data until the execution of printing for the sheet being controlled by the apparatus control unit 200 and the printer unit 210, a full-color toner image is formed on a sheet. In the printer unit 210, a CPU 211, a RAM 212, a communication I/F 214, and a ROM 215 are mounted. The role of each device is the same as the role of each device in the apparatus control unit 200, and therefore, explanation is omitted.

The scanner unit 220 comprises a light source, not shown schematically, a lens, and a solid image sensor, such as a CCD (Charge Coupled Device) sensor. In the scanner unit 220, one document is irradiated with light by a light source. Then, its document reflected image is formed on the solid image sensor, such as a CCD sensor. Further, an image read signal created from the document reflected image is obtained as a multi-valued scanned image of red, green, and blue.

The UI unit 230 is a device capable of inputting various setting values or designated values. The UI unit 230 includes, for example, a keyboard, mouse, display, another input/output device and the like. The sheet feed unit 250 has one or more cassettes for setting sheets to be printed. It is possible for the sheet feed unit 250 to feed a sheet from the cassette corresponding to the sheet size designated in the printing setting and convey the sheet to the printer unit 210. The inspection unit 102 comprises an apparatus control unit 260 and an image reading unit 270. It is possible for the image reading unit 270 to read printed material conveyed from the image processing unit 101.

The image reading unit 270 comprises a light source, not shown schematically, an equal-size-image forming system lens, and a CIS (Contact Image Sensor). In the image reading unit 270, one piece of printed material is irradiated with light by a light source. Then, the reflected image thereof is formed on the CIS via the lens. Further, an image reading signal created from the reflected image is obtained as a multi-valued scanned image of red, green, and blue. In the image reading unit 270 of the present embodiment, the scanned image is obtained by using the CIS, but the scanned image may be obtained by using the CCD sensor.

The apparatus control unit 260 performs control for transferring the scanned image obtained by the image reading unit 270 to the inspection PC 110 via the communication cable 150. In a case where the scanned image is transferred to the inspection PC 110, in the inspection PC 110, whether or not there is an abnormality in the printed material is determined by the scanned image of the printed material and the reference image corresponding to the printed material being compared with each other. The inspection results of the inspection are transmitted from the inspection PC 110 to the image forming apparatus 100.

In the image forming apparatus 100, in a case where the inspection results are received correctly, the inspection results are transmitted to the finisher 103. In the apparatus control unit 260, a CPU 261, a RAM 262, a communication I/F unit 264, and a ROM 265 are mounted. The role of each device is the same as the role of each device comprised by the apparatus control unit 200, and therefore, explanation is omitted.

The finisher 103 comprises an apparatus control unit 280 and a discharge unit 290. In the apparatus control unit 280, the printing setting and the inspection results are taken into consideration and discharge control that is performed in the discharge unit 290 is determined. In the apparatus control unit 280, a CPU 281, a RAM 282, a communication I/F unit 284, and a ROM 285 are mounted. The role of each device is the same as the role of each device comprised by the apparatus control unit 200, and therefore, explanation is omitted.

The discharge unit 290 is a device for performing postprocessing for printed material that is conveyed from the inspection unit 102 in accordance with the printing setting and for switching the discharge destination to another based on the inspection results. For example, the finisher 103 discharges printed material determined to have an abnormality onto a second discharge tray different from a first discharge tray onto which printed material determined to have no abnormality is discharged.

In the present embodiment, an example of the image forming apparatus 100 capable of performing both printing and inspection of printed material is shown. However, the example of the image forming apparatus 100 is not limited to this example. For example, a scanned image obtained by the image forming apparatus 100 scanning printed material may be transmitted to the inspection PC 110 and the inspection of the printed material may be made by the inspection PC 110.

The above is the explanation of the image forming apparatus 100 in the present embodiment.

### <Setting of Inspection and Setting of Inspection Report>

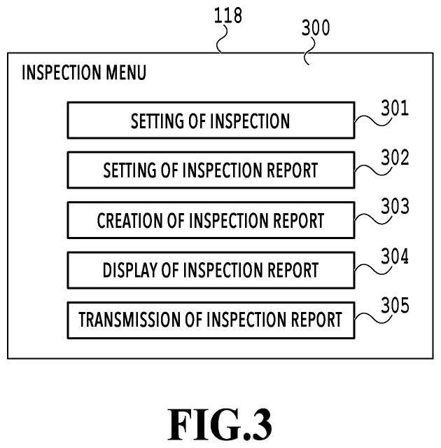

FIG. 3 is a diagram showing one example of a menu screen 300 that can be applied to the present embodiment.

As shown in FIG. 3, the UI unit 118 of the inspection PC 110 (see FIG. 1) is configured so as to be capable of displaying the menu screen 300 for performing the setting of inspection, the setting of an inspection report and the like. The menu screen 300 is displayed on the UI unit 118, for example, in a case where the inspection PC 110 is turned on.

The menu screen 300 includes an inspection setting button 301 for performing the setting relating to inspection and an inspection report setting button 302 for performing the setting relating to an inspection report. The menu screen 300 includes a creation button 303 for creating an inspection report, a display button 304 for displaying an inspection report created in the past, and a transmission button 305 for transmitting an inspection report created in the past to the client PC 120.

Although details will be described later, in the present embodiment, after the inspection to determine whether or not there is an abnormality in printed material printed by the image forming apparatus 100 (not shown schematically in FIG. 3) is made, an inspection report indicating inspection results of the inspection is created.

In the present embodiment, an inspection report is created in a general file format. For example, the inspection report is created in one of the page layout file format, such as the PDF file format and the HTML file format, and the CSV file format. In the present embodiment, explanation is given by taking the PDF file format and the HTML file format as an example of the page layout file format. However, the page layout file format that can be applied to the present embodiment is not limited to the PDF file format and the HTML file format.

PDF (Portable Document Format) is the page layout file format for displaying documents and drawings not depending on the OS or applications. HTML (HyperText Markup Language) is one of markup languages used for representing the configuration of a sentence, drawings, tables and the like on a web page.

The inspection PC 110 (see FIG. 1) of the present embodiment is configured so as to be capable of setting an inspection area, which is the target of inspection in printed material, an inspection level for the inspection area, and the like before inspection is made. The inspection PC 110 is configured so as to be capable of designating a file format in which an inspection report is created and an item that is displayed in an inspection report before an inspection report is created.

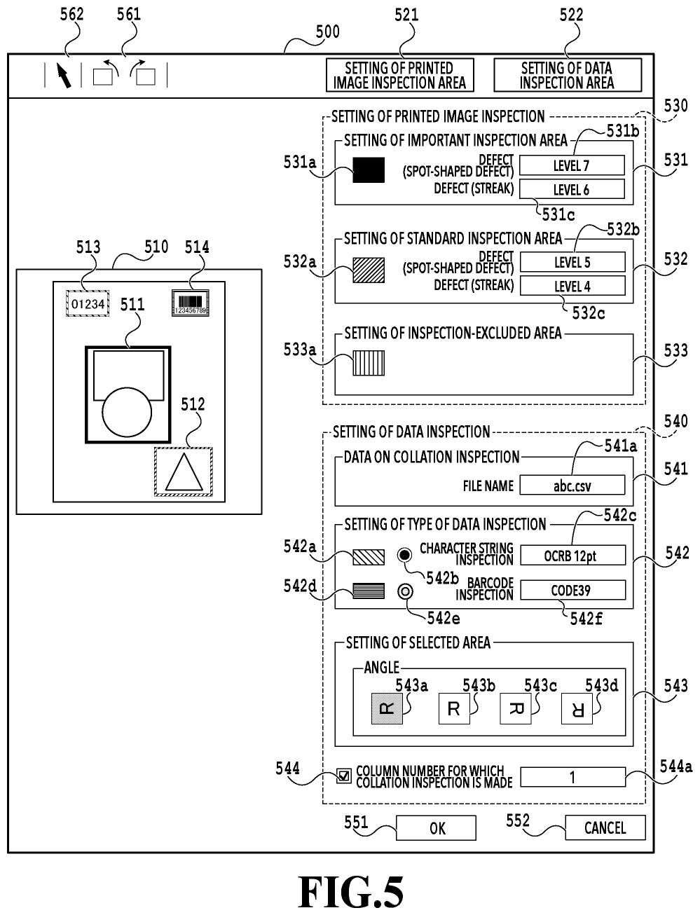

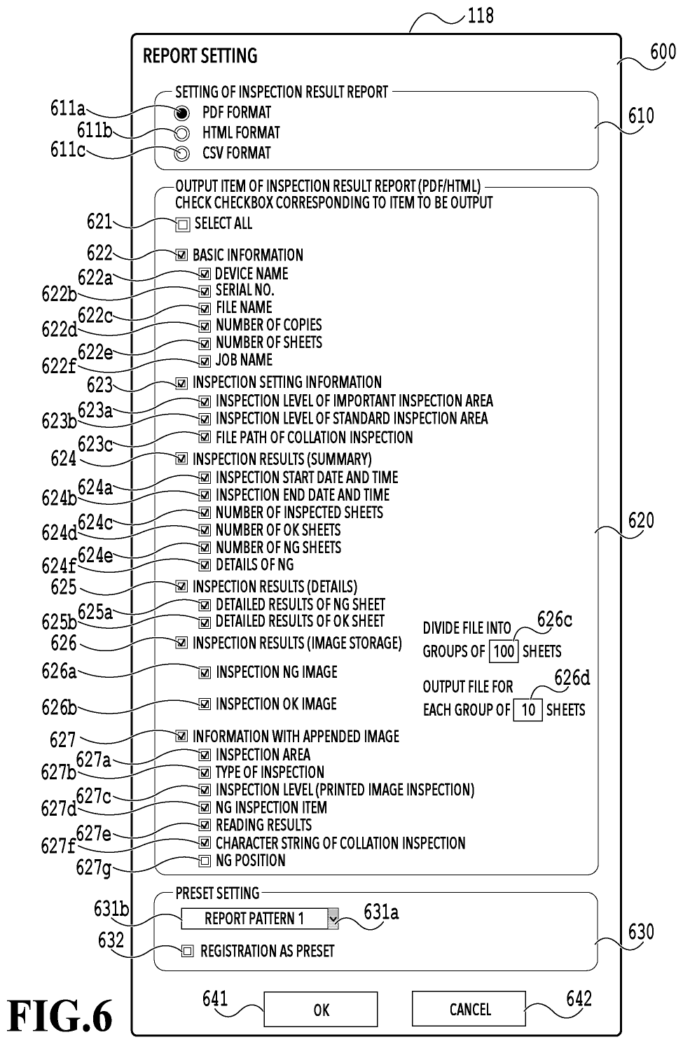

For example, in a case where a user presses down the inspection setting button 301, the menu screen 300 makes a transition into a setting screen 500 (see FIG. 5) for performing the setting relating to inspection. On the setting screen 500, it is possible to set an inspection area, an inspection level for the inspection area and the like. In a case where a user presses down the inspection report setting button 302, the menu screen 300 makes a transition into a Report Setting screen 600 (FIG. 6). On the Report Setting screen 600, it is possible to set an item and the like that are displayed in an inspection report.

In a case where a user presses down the creation button 303, it is made possible to designate a print job with which printing was performed in the past and create an inspection report of the print job. In a case where a user presses down the display button 304, it is made possible to designate an inspection report created in the past and display the inspection report on the UI unit 118. In a case where a user presses down the transmission button 305, it is made possible to designate an inspection report created in the past and transmit the inspection report to the designated client PC 120.

### [Setting Relating to Inspection]

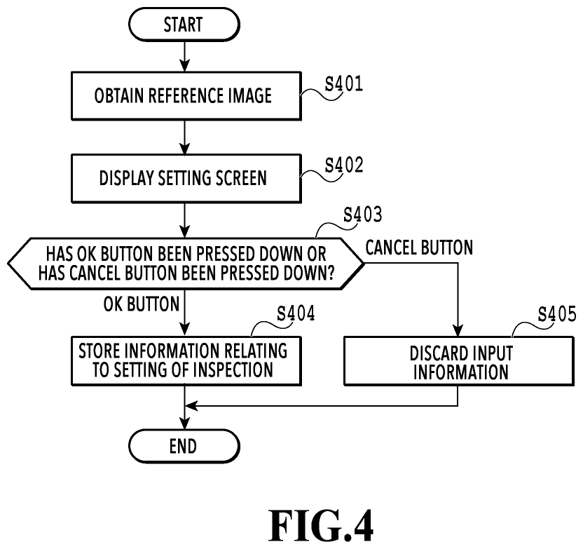

FIG. 4 is a flowchart showing inspection setting processing in the present embodiment. A series of processing shown in the flowchart in FIG. 4 is performed by the CPU 112 loading a program code stored in the ROM 114 onto the RAM 113 and executing the program code. Alternatively, part or all of the functions at steps in FIG. 4 may be implemented by hardware, such as an ASIC and an electronic circuit. A symbol “S” in explanation of each piece of processing means that the step is a step in the flowchart. This is also the same in the drawings after FIG. 4. The series of processing shown in the flowchart in FIG. 4 is started in accordance with the pressing down of the inspection setting button 301 (see FIG. 3).

At S401, the CPU 112 obtains a reference image corresponding to the scanned image of inspection-target printed material. For example, in a case where a plurality of reference images are stored in the storage unit 116, it is possible for a user to designate an arbitrary reference image therefrom. In this case, the CPU 112 obtains the reference image designated by a user. The reference image includes “reference” that is the portion compared with the portion designated as the inspection target in the scanned image of the printed material in a case of inspection. The example of “reference” includes a pictorial pattern portion, a character string, a barcode and the like in the reference image obtained by correctly scanning printed material with no abnormality.

At S402, the CPU 112 displays the setting screen 500 (see FIG. 5) for performing the setting relating to inspection on the UI unit 118.

FIG. 5 is a diagram showing one example of the setting screen 500 of inspection that can be applied to the present embodiment. As shown in FIG. 5, the setting screen 500 is configured so as to be capable of arbitrarily designating an inspection area that is taken as the target of inspection in printed material and designating an inspection level of the inspection area.

In the following, in inspection, inspecting whether or not there is an abnormality in the pictorial pattern portion in printed material by comparing the pictorial pattern portion in the printed material and the pictorial pattern portion for reference is called “printed image inspection.”

In inspection, inspecting whether or not a character string can be read is called “character string inspection” and inspecting whether or not a barcode can be read is called “barcode inspection.” Inspecting reading results of a character string and a barcode by collating them with a reference character string obtained by referring to variable data is called “collation inspection.” The above-described “character string inspection,” “barcode inspection,” and “collation inspection” are called “data inspection” together.

The character type in the present embodiment means a set of font data in which glyph images of characters for character recognition processing (OCR) and character codes are associated with each other. It is necessary to store in advance the set of font data. For example, a glyph image of a character may be printed by a user and registration processing to associate the glyph image and a character code with each other may be performed. Alternatively, a set of corresponding font data may be stored in advance in the shipment state.

Further, an inspection-target area in printed material is called “inspection area.” In the inspection area, the area that is the target of printed image inspection is called “image inspection area.” In the image inspection area, the area for detecting an abnormality of a predetermined size is called “standard inspection area.” In the image inspection area, the area for detecting an abnormality whose size is smaller than the size of an abnormality that is detected inside the “standard inspection area” is called “important inspection area.” In printed material, the area that is not the inspection area is “inspection-excluded area.”

In the inspection area, the area that is the target of data inspection is called “data inspection area.” In the data inspection area, the area that is the target of character string inspection is called “character string inspection area.” In the data inspection area, the area that is the target of barcode inspection is called “barcode inspection area.”

The setting screen 500 includes a page preview 510 in which a reference image designated by a user is displayed, a first area setting button 521 for performing the area setting of printed-image inspection, and a second area setting button 522 for performing the area setting of data inspection. The setting screen 500 includes a first UI group 530 including a plurality of UIs for performing the setting of printed image inspection and a second UI group 540 including a plurality of UIs for performing the setting of data inspection.

The setting screen 500 includes an “OK” button 551 for storing information relating to the setting of inspection set by a user in the storage unit 116 (see FIG. 1) and a “Cancel” button 552 for discarding information relating to the setting of inspection set by a user. The setting screen 500 includes rotation buttons 561 for rotating the reference image displayed in the page preview 510 and a change button 562 for changing information relating to the already set area.

The first UI group 530 includes a UI 531 for performing the setting of an important inspection area, a UI 532 for performing the setting of a standard inspection area, and a UI 533 for performing the setting of an inspection-excluded area. The UI 531 includes an icon 531a displayed in the same color as the color of the frame indicating the area corresponding to the important inspection area in the reference image displayed in the page preview 510. The UI 531 includes a text box 531b and a text box 531c for inputting an inspection level in a case where a spot-shaped defect and a streak are detected, which are detected inside the important inspection area.

The UI 532 includes an icon 532a indicated by the same hatching as the hatching of the frame indicating the area corresponding to the standard inspection area in the reference image displayed in the page preview 510. The UI 532 includes a text box 532b and a text box 532c for inputting an inspection level in a case where a spot-shaped defect and a streak are detected, which are detected in the standard inspection area.

In the present embodiment, “inspection level” means a parameter set for each step for each feature of the detected abnormality, with which to determine what size of an abnormality indicates the presence of an abnormality. For example, “inspection level” includes levels in nine steps from level 1 to level 9. It is possible to detect a thinner abnormality of a smaller size with level 9 than with level 1.

Further, in a case where there is a plurality of types of abnormality to be detected, it is possible for a user to arbitrarily designate the inspection level for each type of abnormality so that a spot-shaped defect is detected with level 7 and a streak is detected with level 6 and so on. In the example in FIG. 5, in the important inspection area, a spot-shaped defect is detected with level 7 and a streak is detected with level 6. On the other hand, in the standard inspection area, a spot-shaped defect is detected with level 5 and a streak is detected with level 4.

In the present embodiment, the inspection level is set so that the inspection level in the important inspection area is higher than the inspection level in the standard inspection area. In the example in FIG. 5, the inspection level of a streak in the standard inspection area is level 4, and therefore, to the text box 531c, level 6 higher than level 4 is input. Explanation has been given by illustrating the method of setting the inspection level of a streak, but the method of setting the inspection level of a spot-shaped defect is the same as the method of setting the inspection level of a streak.

The UI 533 includes an icon 533a indicated by the same hatching as the hatching of the frame indicating the area corresponding to the inspection-excluded area in the reference image displayed in the page preview 510. In the present embodiment, the inspection-excluded area is not designated.

The second UI group 540 includes a UI group 541 for designating a file name that is referred to in a case where collation inspection is performed, a UI group 542 including a plurality of UIs for performing the setting of data inspection, and a UI group 543 including a plurality of UIs for designating the reading direction of printed material. The second UI group 540 includes a checkbox 544 for designating whether or not to designate the column number in a case where collation inspection is performed and a text box 544a for designating the column number of the CSV file that is referred to in a case where the checkbox 544 is checked.

The UI 541 includes a text box 541a for designating the CSV file that is referred to in a case where collation inspection is performed. The UI 542 includes an icon 542a displayed with the same hatching as the hatching of the frame indicating the area corresponding to the character string inspection area in the reference image displayed in the page preview 510.

The UI 542 includes a radio button 542b for designating the area for which character string inspection is made and a text box 542c for designating the character type in a case where character string inspection is made. The UI 542 includes an icon 542d indicated by the same hatching as the hatching of the frame indicating the area corresponding to the barcode inspection area in the reference image displayed in the page preview 510. In the example in FIG. 5, the icon 542d is different from the icon 542a, but they may be the same. The UI 542 includes a radio button 542e for designating the area for which barcode inspection is made and a text box 542f for designating the type of barcode in a case where barcode inspection is mage.

The UI 543 includes a left button 543a displayed in the state where the alphabet character “R” is rotated 90° leftward from the original orientation and an upright button 543b in the state where the character “R” is displayed with the original orientation. The UI 543 includes a right button 543c displayed in the state where the character “R” is rotated 90° rightward from the original orientation and an upside-down button 543d displayed in the state where the character “R” is rotated 180° rightward from the original orientation.

In the following, an example of a method is explained, in which a user designates the inspection area in the reference image displayed in the page preview 510 and designates the inspection level for the inspection area. For example, it is assumed that a user designates an area 511 in a reference image as the important inspection area, an area 512 as the standard inspection area, an area 513 as the character string inspection area, and an area 514 as the barcode inspection area.

First, the designation method of the important inspection area and the designation method of the inspection level for the important inspection area are explained. In this case, a user designates the important inspection area by operating a mouse or the like in the reference image displayed in the page preview 510 after pressing down the first area setting button 521. After that, a user inputs the detection level to each of the text box 531b and the text box 531c. Then, it is possible to designate the important inspection area and designate the inspection level for the important inspection area.

In the present embodiment, the area 511 and the icon 531a are displayed by the same color. Due to this, it is made easier to recognize that the area of the printed material corresponding to the area 511 of the reference image is designated as the important inspection area. As long as it can be seen that the area 511 and the icon 531a correspond to each other with the display format, it is not necessary for the area 511 and the icon 531 to be displayed by the same color. For example, the area 511 and the icon 531a may be displayed with the same hatching.

The above is the explanation of the designation method of the important inspection area and the designation method of the inspection level for the important inspection area. Following the above, the designation method of the standard inspection area and the designation method of the inspection level for the standard inspection area are explained.

A user designates the standard inspection area by operating a mouse or the like in the reference image displayed in the page preview 510 after pressing down the first area setting button 521. After that, a user inputs the inspection level to each of the text box 532b and the text box 532c. Then, it is possible to designate the standard inspection area and the inspection level for the standard inspection area.

In the present embodiment, the area 512 and the icon 532a are displayed with the same hatching. Due to this, it is made easier to recognize that the area of the printed material corresponding to the area 512 of the reference image is designated as the standard inspection area. As long as the display method is a method by which it can be seen that the area 512 and the icon 532a correspond to each other, the area 512 and the icon 532a do not need to be displayed with the same hatching. For example, the area 511 and the icon 531a may be displayed by the same color.

The above is the explanation of the designation method of the standard inspection area and the designation method of the inspection level for the standard inspection area.

Following the above, the designation method of the data inspection area is explained. In the example in FIG. 5, after pressing down the second area setting button 522, by designating the radio button 542b and designating an arbitrary area in the reference image displayed in the page preview 510, it is possible to designate the area designated at that point in time as the character string inspection area.

Further, after pressing down the second area setting button 522, by designating the radio button 542e and designating the arbitrary area in the reference image displayed in the page preview 510, it is possible to designate the area designated at that point in time as the barcode inspection area. In the example in FIG. 5, by the hatching indicating the area 513 being displayed as the same hatching of the icon 542a, it is made easier to recognize that the area of the printed material corresponding to the area 513 of the reference image is designated as the character string inspection area. Then, by the hatching indicating the area 514 being displayed as the same hatching of the icon 542d, it is made easier to recognize that the area of the printed material corresponding to the area 514 of the reference image is designated as the barcode inspection area.

According to the configuration such as this, it is made easier to distinguish between the area in which character string inspection is made and the area in which barcode inspection is made. In the example in FIG. 5, each of the area 513 and the area 514 is indicated by the different types of hatching, but one type of icon may be displayed in the UI 542 and the area 513 and the area 514 may be indicated by the same type of frame. In this case, it is made easier to recognize that the area of the printed material corresponding thereto is designated at least as the data inspection area.

Further, in the example in FIG. 5, to the text box 542c, “OCRB 12 pt” is input. This means that in a case where character recognition processing is performed for the area of the printed material corresponding to the area 513, whether or not the type of character printed in the area is “OCRB 12 pt” is inspected.

Further, in the example in FIG. 5, to the text box 542f, “CODE 39” is input. This means that in a case where barcode inspection is made for the area of the printed material corresponding to the area 514, whether or not the type of barcode printed in the area is “CODE 39” is inspected.

In the present embodiment, it is possible to input the standard of the barcode corresponding to the barcode inspection to the text box 542f. Other than “CODE 39,” for example, it is possible to input the standard of one-dimensional code, such as “JAN code,” to the text box 542f. Other than these, for example, it is possible to input two-dimensional code, such as “QR code (registered trademark)” and “DataMtrix code,” to the text box 542f.

Further, in the UI group 543, the left button 543a, the upright button 543b, the right button 543c, and the upside-down button 543d are displayed. The character “R” of each of the left button 543a, the upright button 543b, the right button 543c, and the upside-down button 543d is displayed so as to correspond to the clockwise rotation of 0°, 90°, 180°, and 270° respectively in the interval of 90 degrees with respect to the sheet conveyance direction.

In the image forming apparatus 100 (not shown schematically in FIG. 5) of the present embodiment, the sheet is conveyed from right to left inside the page preview 510. Because of that, in the example in FIG. 5, the left button 543a is designated so as to correspond to the sheet conveyance direction (from right to left in FIG. 5) and the orientation of the character “R” (leftward with respect to the original orientation). That is, in the present embodiment, in a case where the left button 543a is designated, the reading angle of the printed material is set to “0°.”

As above, in the present embodiment, it is possible to designate the direction in which a character string and barcode are read so as to correspond to the sheet conveyance direction. In the example in FIG. 5, the left button 543a, the upright button 543b, the right button 543c, and the upside-down button 543d are used, but in a case where it is possible to designate the direction in which a character string and barcode are read, radio buttons and the like may be used.

Further, in a case where the checkbox 544 is checked, which column is referred to as the reference character string in the CSV file is determined by the input value in the text box 544a. For example, to the text box 544a, an integer “1” or more is input. In a case where a CSV file is read in advance, the upper limit value that can be input to the text box 544a may be the maximum column number thereof.

In the present embodiment, the column number that is referred to is designated by the text box 544a, but a pull-down text box may be used, in which the first row of variable data is read in advance and the first row is taken as the label value. The method is not limited to these examples and any method may be adopted as long as it is possible to designate the column number that is referred to in the CSV file.

Further, the text box 544a may be configured so that it is not possible to input anything to the text box 544a because in a case where the checkbox 544 is not designated, the column that is referred to in the CSV file is not designated. In a case where the checkbox 544 is not checked, the text box 544a may be, for example, grayed out.

The above is the explanation of the designation method of the data inspection area.

By the “OK” button 551 being pressed down, information relating to the setting of inspection, which has been designated so far by a user, is stored in the storage unit 116. That is, the setting of inspection is completed. On the other hand, the “Cancel” button 552 is a button for aborting the setting of inspection. In a case where the “Cancel” button 552 is pressed down by a user, information relating to the setting of inspection, which has been designated so far by a user, is discarded.

The above is the explanation of the setting of inspection in the present embodiment. Even after the above-described setting of inspection is completed, it is possible to perform the setting again by a user calling the setting screen 500 again.

In the following, with reference to FIG. 4 again, inspection setting processing in the present embodiment is explained.

At S403, the CPU 112 determines whether the “OK” button 551 has been pressed down or the “Cancel” button 552 has been pressed down during the display of the setting screen 500 shown in FIG. 5. In a case where the “OK” button 551 has been pressed down, the CPU 112 performs processing at S404. On the other hand, in a case where the “Cancel” button 552 has been pressed down, the CPU 112 performs processing at S405.

At S404, the CPU 112 stores the information relating to the setting of inspection input via the setting screen 500 in the storage unit 116. As the information relating to the setting of inspection, the positions of the inspection area and the inspection-excluded area, the type of abnormality that is detected in the inspection area, and the inspection level in a case where the abnormality is detected are stored, which are all designated by a user. Of course, information relating to the setting of inspection other than that described above may be stored. After the processing at S404 is completed, the CPU 112 terminates the processing.

At S405, the CPU 112 discards the information relating to the setting of inspection input via the setting screen 500. The display of the setting screen 500 may also be terminated. After the processing at S405 is completed, the CPU 112 terminates the processing.

The above is the explanation of the inspection setting processing in the present embodiment.

### <Setting of Inspection Report Storage Format and Output Item>

FIG. 6 is a diagram showing one example of the Report Setting screen 600 that can be applied to the present embodiment. In a case where the inspection report setting button 302 (see FIG. 3) is pressed down in the UI unit 118, the menu screen 300 (FIG. 3) makes a transition into the Report Setting screen 600. The Report Setting screen 600 is displayed on the UI unit 118 for performing the setting of the inspection report storage format and the output item.

As shown in FIG. 6, the Report Setting screen 600 includes a UI group 610 including a plurality of radio buttons, a UI group 620 including a plurality of checkboxes, and a UI group 630 including a plurality of UIs for performing the preset of report patterns. The Report Setting screen 600 includes an “OK” button 641 for storing information relating to the inspection report setting in the storage unit 116 and a “Cancel” button 642 for discarding information relating to the inspection report setting.

The UI group 610 includes a radio button 611a for creating and storing an inspection report in the PDF format, a radio button 611b for creating and storing an inspection report in the HTML format, and a radio button 611c for creating and storing an inspection report in the CSV format.

In a case where an inspection report is checked, there is a case where the inspection area and the inspection level of the inspection area are checked as well as the inspection results. Generally, the inspection level is checked by using an inspection-dedicated application. In many cases, the inspection-dedicated application is installed in an inspection-dedicated PC (for example, the inspection PC 110 in FIG. 1) and it is extremely rare for the inspection-dedicated application to be installed in a general external device (for example, the client PC 120 in FIG. 1). That is, it is difficult to check the inspection level by using a general PC.

Consequently, in the present embodiment, the inspection report is created in the general file format designated by a user so that the inspection level is displayed along with the scanned image of the printed material. According to the inspection report of the present embodiment, it is made possible to check the scanned image of the printed material and the inspection level by using an external device in which the general OS is installed without the need for using the inspection-dedicated application.

The UI group 620 includes a plurality of checkboxes for designating items that are output in a case where the inspection report is output in the PDF format or the HTML format. On the other hand, in a case where the inspection report is output in the CSV format, the items that are output in the inspection report are determined in advance, and therefore, it is not necessary to use the UI group 620.

The UI group 620 may be configured so that checkboxes in the UI group 620 cannot be designated in a case where the inspection report is output in the CSV format. For example, in a case where the radio button 611c is designated, the entire UI group 620 is grayed out. According to the configuration such as this, it becomes easier to recognize that the inspection report is designated to be created in the CSV format, and therefore, it is possible to reduce the possibility of an erroneous input to the UI group 620.

In the UI group 620, it is possible to individually check each of the plurality of checkboxes and cancel the checked state. In the UI group 620, in a case where a checkbox 621 is checked, all checkboxes in the UI group 620 are checked.

A checkbox 622 is a checkbox for designating items relating to basic information in the inspection report. The basic information in the inspection report in the present embodiment includes device a name, serial No. (number), file name, number of copies, number of sheets, and job name. A checkbox 622a is a checkbox for designating whether or not to display the device name in the inspection report. A checkbox 622b is a checkbox for designating whether or not to display the serial number in the inspection report. A checkbox 622c is a checkbox for designating whether or not to display the file name in the inspection report. A checkbox 622d is a checkbox for designating whether or not to display the number of copies in the inspection report. A checkbox 622e is a checkbox for designating whether or not to display the number of sheets in the inspection report. A checkbox 622f is a checkbox for designating whether or not to display the job name in the inspection report. In a case where the checkbox 622 is checked, all the checkboxes 622a to 622f are checked.

A checkbox 623 is a checkbox for designating items relating to the inspection setting in the inspection report. The items relating to the inspection setting in the present embodiment include an inspection level of important inspection area, inspection level of standard inspection area, and file path of collation inspection. A checkbox 623a is a checkbox for designating whether or not to display the inspection level of the important inspection area in the inspection report. A checkbox 623b is a checkbox for designating whether or not to display the inspection level of the standard inspection area in the inspection report. A checkbox 623c is a checkbox for designating whether or not to display the file path of collation inspection in the inspection report. In a case where the checkbox 623 is checked, all the checkboxes 623a to 623c are checked.

A checkbox 624 is a checkbox for designating items relating to the summary of inspection results in the inspection report. The items relating to the summary of inspection results in the present embodiment includes inspection start a date and time, inspection end date and time, number of inspected sheets, number of OK sheets, number of NG sheets, and details of NG. The number of OK sheets means the number of printed materials determined to have no abnormality. The number of NG sheets means the number of printed materials determined to have an abnormality. The details of NG mean details of the abnormality having occurred in the printed material.

A checkbox 624a is a checkbox for designating whether or not to display the inspection start date and time in the inspection report. A checkbox 624b is a checkbox for designating whether or not to display the inspection end date and time in the inspection report. A checkbox 624c is a checkbox for designating whether or not to display the number of printed materials for which inspection has been made in the inspection report. A checkbox 624d is a checkbox for designating whether or not to display the number of printed materials determined to have no abnormality. A checkbox 624e is a checkbox for designating whether or not to display the number of printed materials determined to have an abnormality. A checkbox 624f is a checkbox for designating whether or not to display the details of the abnormality having occurred in the printed material. In a case where the checkbox 624 is checked, all the checkboxes 624a to 624f are checked.

A checkbox 625 is a checkbox for designating whether or not to display detailed information on inspection results in the inspection report. The detailed information on inspection results in the present embodiment includes detailed information on NG sheet and detailed information on OK sheet. A checkbox 625a is a checkbox for designating whether or not to display detailed information on an abnormality of the printed material determined to have an abnormality in the inspection report. A checkbox 625b is a checkbox for designating whether or not to display information indicating that there is no abnormality, another pieces of detailed information and the like of the printed material determined to have no abnormality in the inspection report. In a case where the checkbox 625 is checked, all the checkboxes 625a and 625b are checked.

A checkbox 626 is a checkbox for designating whether or not to store the scanned image of the printed material along with the inspection report. A checkbox 626a is a checkbox for designating to store the scanned image (inspection NG image) of the printed material determined to have an abnormality. A checkbox 626b is a checkbox for designating to store the scanned image (inspection OK image) of the printed material determined to have no abnormality. In the state where the checkbox 626a or the checkbox 626b is designated, it is possible to input the number sheets in a case where a file is divided and stored to a text box 626c included in the UI group 620.

In the example in FIG. 6, to the text box 626c, “100” is input. In this case, the file of the inspection report is divided into groups of 100 sheets and stored, such as a group of the first sheet to the 100th sheet, a group of the 101st sheet to 200th sheet, and a group of 201 st sheet to 300th sheet, and so on. As described above, in a case where a comparatively large number of printed materials are inspected, by dividing and storing the inspection report, it is possible to suppress an increase in the capacity of the file for each file. The file of the inspection report may be divided into groups of a predetermined number of sheets and stored.

A text box 626d is a text box for displaying the scanned image of the printed material determined to have no abnormality as the inspection report for each number of sheets corresponding to the input number. In the example in FIG. 6, to the text box 626d, “10” is input. In the inspection report in this case, the scanned image is displayed for each ten sheets, such as the first sheet, the 11th sheet, and 21st sheet. According to the configuration such as this, in a case where a comparatively large number of printed materials are inspected, it is possible to reduce the data capacity by reducing the number of scanned images that are stored along with the inspection report.

A checkbox 627 is a checkbox for designating items of information (information with appended image) that is displayed along with the scanned image of the printed material. The information with appended image in the present embodiment includes an inspection area, inspection type, inspection level (only printed image inspection), inspection item of NG, reading results, character string of collation inspection, and NG position. The inspection item of NG means the item of inspection that has been performed for the printed material determined to have an abnormality. The NG position means the position at which the abnormality of the printed material has occurred.

A checkbox 627a is a checkbox for designating to display the area that has been taken as the target of inspection along with the scanned image of the printed material in the inspection report. A checkbox 627b is a checkbox for designating to display the type of inspection that has been made along with the scanned image of the printed material in the inspection report. A checkbox 627c is a checkbox for designating to display the inspection level set for the area that has been taken as the target of inspection along with the scanned image of the printed material in the inspection report. A checkbox 627d is a checkbox for designating to display the type of abnormality that has occurred in the area that has been taken as the target of inspection along with the scanned image of the printed material in the inspection report. A checkbox 627e is a checkbox for designating to display the reading results of the character string and the barcode along with the scanned image of the printed material in the inspection report. A checkbox 627f is a checkbox for designating to display the correct character string that should be read originally along with the scanned image of the printed material in the inspection report. A checkbox 627g is a checkbox for designating to display the position at which the abnormality has occurred along with the scanned image of the printed material in the inspection report.

The UI group 630 includes a pull-down button 631a for designating the report pattern and a window 631b displaying the report pattern name. The UI group 630 includes a checkbox 632 for registering information relating to the input setting of the inspection report as the preset report pattern.

The pull-down button 631a is a button for designating the report pattern preset in the past. By pressing down the pull-down button 631a and designating the report pattern displayed in the window 631b, it is possible to call the preset report pattern. Specifically, by the preset setting values being switched, the corresponding preset setting value pattern is called and the setting value of each checkbox is overwritten. The checkbox 632 is a checkbox that is designated in a case where it is desired to store the input patterns of the radio button, the checkbox, and the text box, which are currently being input, as new report patterns.

It is assumed that the “OK” button 641 is pressed down in the state where the report pattern displayed in the window 631b is called and the checkbox 632 is designated. In this case, the preset setting value corresponding to the called report pattern is overwritten by the setting value currently being input.

On the other hand, it is assumed that the “OK” button 641 is pressed down in the state where the preset report pattern is not called and the checkbox 632 is designated. In this case, as a new preset report pattern, the setting value currently being input is registered as a new preset report pattern.

In order to store a new preset report pattern, it may also be possible to prepare in advance the item, blank and the like of “new preset registration” as an option of the window 631b and enable storage of a new preset report pattern.

The “OK” button 641 is a button for storing the contents set so far by a user in the storage device 116. In a case where the “OK” button 641 is pressed down, the contents of the setting in creating the inspection report designated by a user are stored in the storage device 116. The “Cancel” button 642 is a button for aborting the setting of the inspection report. In a case where the “Cancel” button 642 is pressed down by a user, the information being set is discarded.

In a case where it is not necessary, in the state where a certain item is designated, to designate the item relating to the certain item, the item may be grayed out so that the item cannot be designated. That is, the inspection application may be configured so that the input to the item is invalidated.

For example, in a case where the scanned image of printed material with an abnormality is not displayed in the inspection report, it is not necessary to display an inspection type, inspection item of NG, reading results, character string of collation inspection, and NG position. That is, in a case where the checkbox 626a is not designated, the checkbox 627b, the checkbox 627d, the checkbox 627e, the checkbox 627f, and the checkbox 627g may be grayed out.

In the present embodiment, the item that is displayed in the inspection report is set via the Report Setting screen 600, but the item that is displayed in the inspection report may be set as a predefined value as in the environmental setting without using the Report Setting screen 600. Then, the inspection application may be configured so that in a case where a predefined value as in the environmental setting is set and the scanned image of printed material determined to have no abnormality is not stored, the scanned image is not stored during the inspection of the printed material. The inspection application may be configured so that also in a case where the scanned image of printed material determined to have an abnormality is not stored, the scanned image is not stored during the inspection of the printed material.

The above is the explanation of the Report Setting screen 600 in the present embodiment.

### <Flow of the Entire Print Processing in the Present Embodiment>

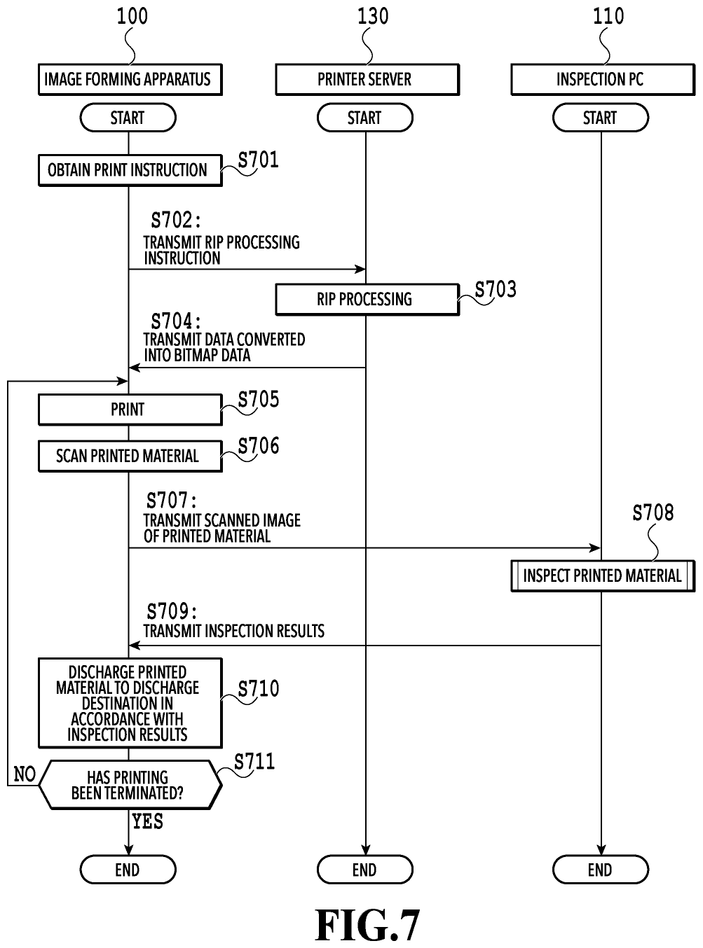

FIG. 7 is a sequence diagram showing a flow of the entire print processing in the present embodiment. For example, in a case where the image forming apparatus 100 (not shown schematically in FIG. 7) receives instructions to perform a print job, a series of processing shown in the sequence diagram in FIG. 7 is started. In the following, along the sequence diagram in FIG. 7, operations between each apparatus and device are explained in a time series.

At S701, the image forming apparatus 100 obtains instructions to print document data and written material data included in the print job. After the processing at S701 is completed, the image forming apparatus 100 performs processing at S702.

At S702, the image forming apparatus 100 transmits RIP processing instructions to perform RIP processing for the document data and written material data obtained at S701 to the printer server 130. After the completion of the processing at S702, the printer server 130 performs processing at S703.

At S703, the printer server 130 performs RIP processing for the document data and written material data transmitted from the image forming apparatus 100. After the completion of the processing at S703, the printer server 130 performs processing at S704.

At S704, the printer server 130 transmits the document data and written material data converted into bitmap data by the RIP processing to the image forming apparatus 100. After the completion of the processing at S704, the image forming apparatus 100 performs processing at S705.

At S705, the image forming apparatus 100 performs printing based on the document data and written material data converted into bitmap data. After the completion of the processing at S705, the image forming apparatus 100 performs processing at S706.

At S706, the image forming apparatus 100 scans the printed material printed at S705. After the completion of the processing at S706, the image forming apparatus 100 performs processing at S707.

At S707, the image forming apparatus 100 transmits the scanned image obtained by scanning the printed material at S706 to the inspection PC 110. After the completion of the processing at S707, the inspection PC 110 performs processing at S708.

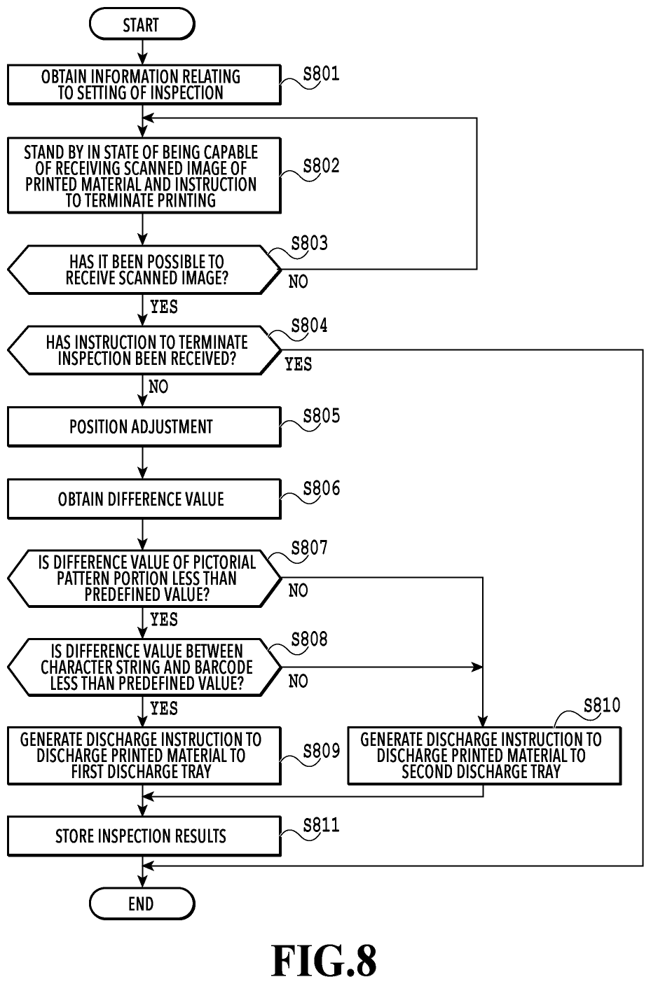

At S708, the inspection PC 110 inspects whether or not there is an abnormality in the printed material printed at S705. Details of S708 will be described later by using FIG. 8. After the completion of the processing at S708, the inspection PC 110 performs processing at S709.

At S709, the inspection PC 110 transmits the inspection results of the printed material to the image forming apparatus 100. After the completion of the processing at S709, the image forming apparatus 100 performs processing at S710.

At S710, the image forming apparatus 100 discharges the printed material to the discharge destination in accordance with the inspection results. For example, as described above, the printed material determined to have no abnormality is discharged onto the first discharge tray and the printed material determined to have an abnormality is discharged onto the second discharge tray. According to this configuration, the printed material determined to have an abnormality is discharged onto the second discharge tray different from the first discharge tray, and therefore, it is made easier to recognize that an abnormality has occurred in the printed material.

In a case where the printed material is determined to have an abnormality at S708, printing may be performed again in order to recover the abnormality. In this case, printing is performed again each time an abnormality is determined to exist, and therefore, on the first discharge tray in the finisher 103 (not shown schematically in FIG. 7), the possibility of the completion of a set of printed materials without any abnormality becomes strong. After the completion of the processing at S710, the image forming apparatus 100 performs processing at S711.

At S711, the image forming apparatus 100 determines whether or not printing is completed by a publicly known method. In the present embodiment, as a pattern with which printing is completed, two cases are supposed. The first is a case where printing of all the printed materials included in the print job is completed. The second is a case where printing of the printed material included in the print job is aborted by a user. For example, in a case where many printed materials determined to have an abnormality are discharged continuously, the possibility that the further continuation of printing will be wasteful is strong. In this case, even on a condition that printing of all the printed materials included in the print job is not completed, it may happen sometimes that printing is terminated. Even in a case where printing is aborted, it is possible to create the inspection report of the printed material for which printing has been performed.

In a case where printing is completed (YES at S711), the image forming apparatus 100 terminates the processing. On the other hand, in a case where printing is not completed (NO at S711), the image forming apparatus 100 repeats the processing at S705.

The above is the explanation of the flow of the entire print processing in the present embodiment. After the processing at S711, by pressing down the creation button 303 on the menu screen 300 in FIG. 3, it is made possible to create an inspection report. [Details of inspection processing]

FIG. 8 is a flowchart showing a subroutine of the inspection processing (S708 in FIG. 7) in the present embodiment.

At S801, the CPU 112 obtains the information relating to the inspection setting stored in the storage unit 116 at S404 (see FIG. 4) and temporarily stores the information in the RAM 113. After the completion of the processing at S801, the CPU 112 performs processing at S802.

At S802, the CPU 112 stands by for a predetermined time in the state of being capable of receiving the scanned image of the printed material obtained by performing a scan at S706 (see FIG. 7) and instructions to terminate printing. After the completion of the processing at S802, the CPU 112 performs processing at S803.

At S803, the CPU 112 determines whether or not it has been possible to receive the scanned image during the standby at S802. In a case where it has not been possible to receive the scanned image (NO at S803), the CPU 112 repeats the processing at S802.

On the other hand, in a case where it has been possible to receive the scanned image (YES at S803), the CPU 112 performs processing at S804.

At S804, the CPU 112 determines whether or not instructions to terminate inspection have been received during the standby at S802. In a case where instructions to terminate inspection have been received (YES at S804), the CPU 112 terminates the processing. On the other hand, in a case where instructions to terminate inspection have not been received (NO at S804), the CPU 112 performs processing at S805.

At S805, the CPU 112 performs position adjustment by comparing the scanned image in the printed material and the reference image corresponding to the printed material. After the completion of the processing at S805, the CPU 112 performs processing at S806.

At S806, the CPU 112 obtains the difference value between the inspection target of the scanned image in the printed material, which is obtained by the processing at S805, and the reference of the reference image corresponding to the printed material. After the completion of the processing at S806, the CPU 112 performs processing at S807.

At S807, the CPU 112 determines whether or not the difference value between the pictorial pattern portion designated as the inspection target and the reference corresponding to the pictorial pattern portion (pictorial pattern portion of the reference image) is less than a predefined value. In a case where the difference value between the pictorial pattern portion designated as the inspection target and the reference corresponding to the pictorial pattern portion (pictorial pattern portion of the reference image) is less than the predefined value (YES at S807), the CPU 112 performs processing at S808. On the other hand, in case where the difference value between the pictorial pattern portion designated as the inspection target and the reference corresponding to the pictorial pattern portion (pictorial pattern portion of the reference image) is greater than or equal to the predefined value (NO at S807), the CPU 112 performs processing at S810.

At S808, the CPU 112 determines whether or not the difference value between the character string and barcode designated as the inspection target and the reference corresponding to the character string and barcode (character string and barcode of the reference image) is less than a predefined value. In a case where the difference value between the character string and barcode designated as the inspection target and the reference corresponding to the character string and barcode (character string and barcode of the reference image) is less than the predefined value (YES at S808), the CPU 112 performs processing at S809. On the other hand, in a case where the difference value between the character string and barcode designated as the inspection target and the reference corresponding to the character string and barcode (character string and barcode of the reference image) is greater than or equal to the predefined value (NO at S808), the CPU 112 performs processing at S810.

In the present embodiment, after whether or not there is an abnormality in the pictorial pattern portion of the printed material is inspected, whether or not there is an abnormality in the character string and barcode of the printed material is inspected, but these inspections may be made in parallel. Then, in a case where an abnormality is determined to exist in one of both the inspections, the processing at S810 may be performed.

At S809, the CPU 112 of the inspection PC 110 generates discharge instructions to discharge the printed material onto the first discharge tray. After the completion of the processing at S809, the CPU 112 performs processing at S811.

At S810, the CPU 112 of the inspection PC 110 generates discharge instructions to discharge the printed material onto the second discharge tray. After the completion of the processing at S810, the CPU 112 performs processing at S811.

At S811, the CPU 112 stores the inspection results of the printed material in the storage unit 116. Due to this, even in a case where printing is aborted and all the document data and written material data included in the print job have not been printed, for the printed material that has been printed, it is made possible to create the inspection report for each print job. After the completion of the processing at S811, the CPU 112 terminates the processing.

The above is the explanation of the subroutine in the inspection processing (S708 in FIG. 7) in the present embodiment.

### [Creation of Inspection Report]

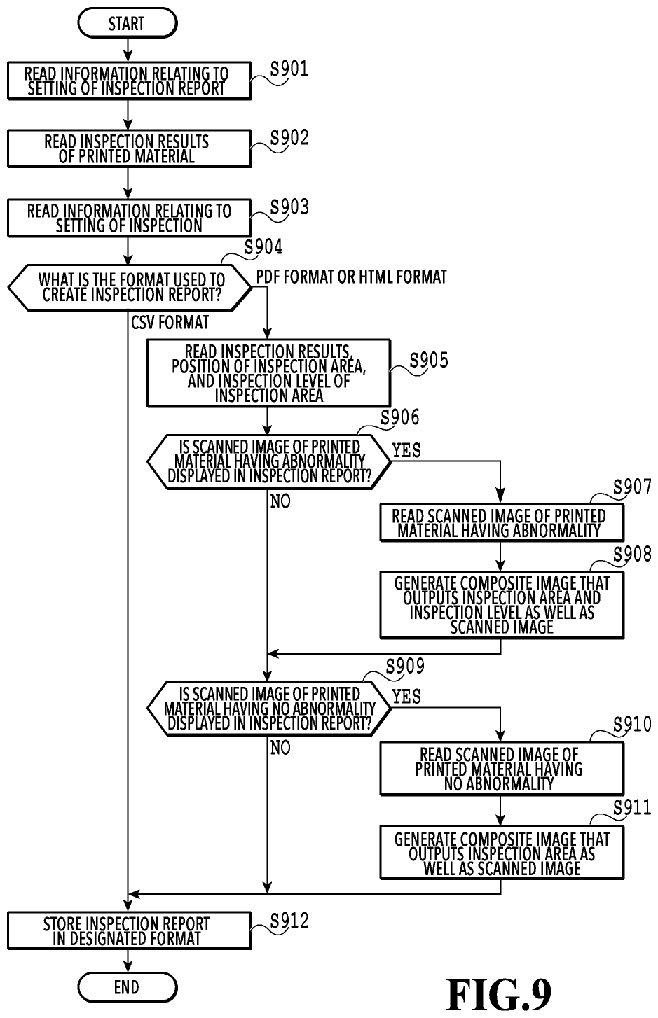

FIG. 9 is a flowchart showing a flow of processing in a case where an inspection report is created in the present embodiment. For example, in accordance with the pressing down of the creation button 303 (see FIG. 3), the print job performed in the past is displayed on the UI unit 118 (see FIG. 1) and in accordance with the print job for which the inspection report is created being designated, a series of processing shown in FIG. 9 is started.

At S901, the CPU 112 refers to the storage unit 116 and reads information relating to the inspection report setting. Specifically, the information on the format in which the inspection report is created and relating to the item that is displayed in the inspection report is read. After the completion of the processing at S901, the CPU 112 performs processing at S902.

At S902, the CPU 112 refers to the storage unit 116 and reads the inspection results of the printed material. After the completion of the processing at S902, the CPU 112 performs processing at S903.

At S903, the CPU 112 refers to the storage unit 116 and reads the information relating to the inspection setting including the position of the inspection area and the inspection level set for the inspection area. After the completion of the processing at S903, the CPU 112 performs processing at S904.

At S904, the CPU 112 determines which of the PDF format, the HIML format, or the CSV format is designated as the format in which the inspection report is created and stored based on the information read at S901. In a case where the PDF format or the HTML format is designated, the CPU 112 performs processing at S905. On the other hand, in a case where the CSV format is designated, the CPU 112 performs processing at S912.

At S905, the CPU 112 reads the inspection results, the position of the inspection area, and the inspection level of the inspection area for each printed material based on the information read at S903. In addition to the above, for example, the type of frame indicating the inspection area, the type of abnormality that is inspected in the inspection area, the specific position at which the abnormality has occurred and the like may be read. After the completion of the processing at S905, the CPU 112 performs processing at S906.

At S906, the CPU 112 determines whether or not to display the scanned image of the printed material determined to have an abnormality in the inspection report based on the information read at S901. In a case where the scanned image of the printed material determined to have an abnormality is displayed in the inspection report (YES at S906), the CPU 112 performs processing at S907. On the other hand, in a case where the scanned image of the printed material determined to have an abnormality is not displayed in the inspection report (NO at S906), the CPU 112 performs processing at S909.

At S907, the CPU 112 refers to the storage unit 116 and reads the scanned image of the printed material determined to have an abnormality. After the completion of the processing at S907, the CPU 112 performs processing at S908.

At S908, the CPU 112 generates a composite image that outputs the position of the inspection area and the inspection level that is set for the inspection area as well as the scanned image of the printed material determined to have an abnormality. Specifically, a superimposed image is generated in which the frame indicating the inspection area that is set for the printed material and the inspection level of the inspection area are displayed in a superimposition manner on the scanned image of the printed material determined to have an abnormality.

Information that can be displayed on the scanned image of the printed material in a superimposition manner is not limited to the inspection level. A superimposed image may be generated in which the various items included in the UI group 620 (see FIG. 6) are displayed in a superimposition manner on the scanned image of the printed material determined to have an abnormality. After the completion of the processing at S908, the CPU 112 performs processing at S909.

At S909, the CPU 112 determines whether or not to display the scanned image of the printed material determined to have no abnormality in the inspection report based on the information obtained at S901. In a case where the scanned image of the printed material determined to have no abnormality is displayed in the inspection report (YES at S909), the CPU 112 performs processing at S910. On the other hand, in a case where the scanned image of the printed material determined to have no abnormality is not displayed in the inspection report (NO at S909), the CPU 112 performs processing at S912.

At S910, the CPU 112 reads the scanned image of the printed material determined to have no abnormality into the inspection report. After the completion of the processing at S910, the CPU 112 performs processing at S911.

At S911, the CPU 112 generates a composite image that outputs information indicating the position of the inspection area as well as the scanned image of the printed material determined to have no abnormality. For example, a superimposed image is generated in which information indicating the position of the inspection area is displayed in a superimposition manner on the scanned image of the printed material determined to have no abnormality. As the example of the information indicating the position of the inspection area, there are a frame and mask indicating the position of the inspection area, coordinates and the like. Of course a superimposed image may be generated in which the inspection level of the inspection area is displayed in a superimposition manner on the scanned image of the printed material determined to have no abnormality. After the completion of the processing at S911, the CPU 112 performs processing at S912.

At S912, the CPU 112 stores the inspection report in the format designated by a user among the PDF format, the HTML format, and the CSV format based on the information obtained at S901. After the completion of the processing at S912, the CPU 112 terminates the processing.

According to the configuration such as this, the inspection report is stored in the general file format, and therefore, it is possible to check the inspection results without the need to use an inspection-dedicated application. Particularly, in a case where the inspection report is created in the PDF format or the HTML format, it is possible to check the scanned image of the printed material and the inspection level set for the inspection area without the need to use an inspection-dedicated application.

The above is the explanation of the subroutine in the inspection (S715 in FIG. 7) in the present embodiment.

### <Inspection Report>

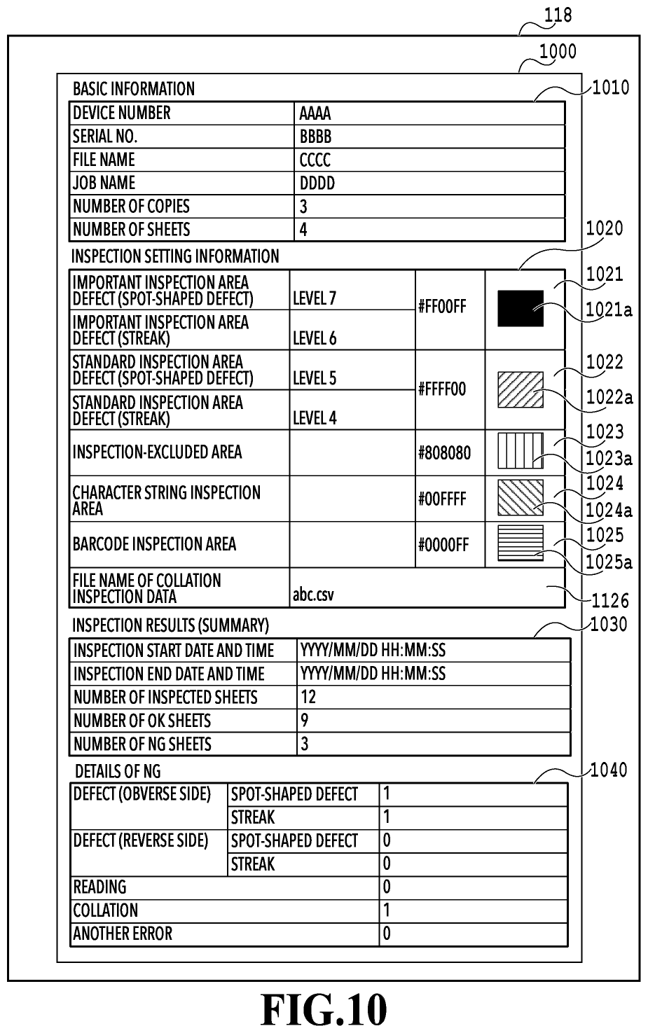

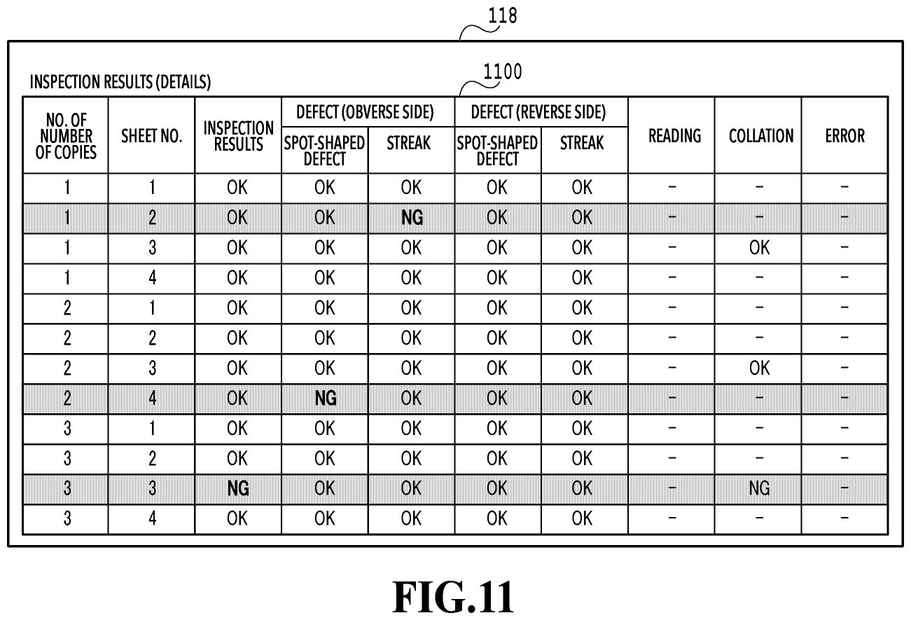

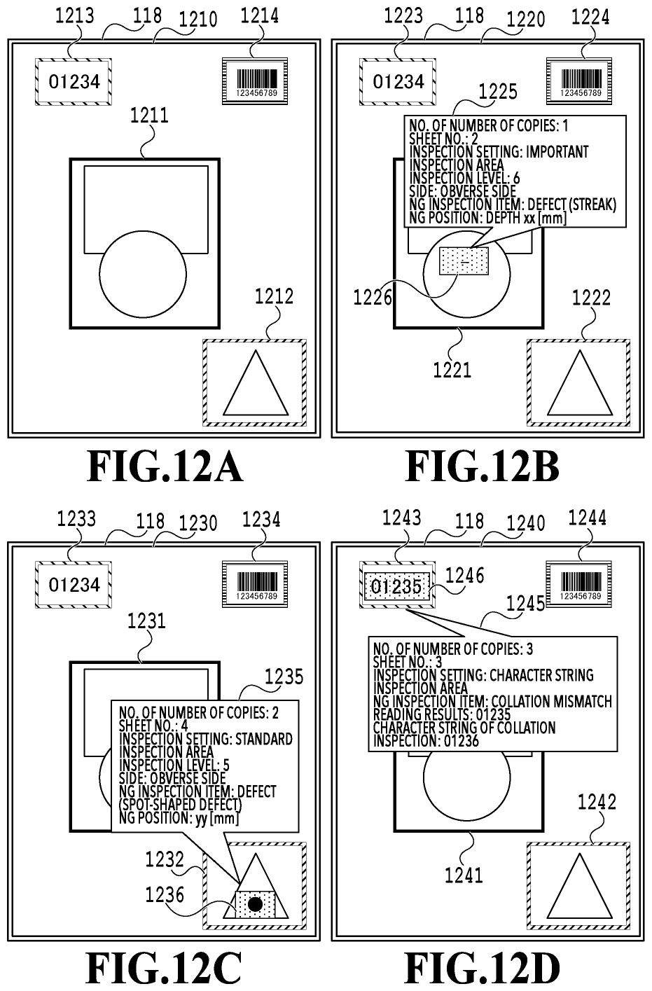

In the following, an example of the inspection report that can be output to the UI unit 118 of the present embodiment is explained. First, an example of the inspection report that is displayed in the PDF format is explained, and then, explanation is given by taking an example of the inspection report that is displayed in the CSV format. In a case where the inspection report is displayed in the PDF format, the inspection report is displayed by being largely divided into a first portion 1000 (see FIG. 10), a second portion 1100 (see FIG. 11), and third portions 1210 to 1240 (see FIG. 12A to FIG. 12D).

The first portion 1000 (see FIG. 10) is “inspection report (summary)” and includes information relating to the summary of the entire inspected print job. The second portion 1100 (see FIG. 11) is “inspection report (details)” and includes detailed information relating to the inspection results of each page of the inspected printed material. The third portions 1210 to 1240 (see FIG. 12A to FIG. 12D) are each “inspection report (image)” and include at least the scanned image of the printed material. The inspection report of the present embodiment is displayed on the UI unit 118 in a case where, for example, the display button 304 (see FIG. 3) is pressed down after the processing at S912 (see FIG. 9).

### <Inspection Report (Summary)>

FIG. 10 is a diagram showing one example of the first portion 1000 that functions as “inspection report (summary).”

As shown in FIG. 10, the first portion 1000 includes a first item 1010 displaying information relating to basic information on inspection, a second item 1020 displaying information relating to the setting of inspection, and a third item 1030 displaying the summary of inspection results. The first portion 1000 includes a fourth item 1040 displaying the detailed breakdown relating to the abnormality having occurred.

In the first item 1010, information on the model type used mainly for printing (device number, serial No. and the like) and information on the entire inspection-target print job (file name, job name set in the inspection job, number of copies to be printed, number of pages per copy and the like) are displayed. In the first item 1010, the items designated as basic information among the checkboxes 622a to 622f (see FIG. 6) are displayed. The item not designated among the checkboxes 622a to 622f is excluded and the item under the excluded item is moved upward and displayed.

In the second item 1020, the inspection levels of the important inspection area and the standard inspection area, information relating to the color displaying each inspection area, information relating to the file name that is used for collation inspection data, and the like are displayed. The second item 1020 includes an area 1021 indicating information set for the important inspection area, an area 1022 indicating information set for the standard inspection area, and an area 1023 indicating information set for the inspection-excluded area. The second item 1020 includes an area 1024 indicating information set for the character string inspection area, an area 1025 indicating information set for the barcode inspection area, and an area 1026 indicating the file name that is referred to in a case of collation inspection. The setting relating to the inspection level and the color displaying each inspection area is displayed so as to match the information set via the Report Setting screen 600 (see FIG. 6).

The area 1021 includes an icon 1021a indicating the area corresponding to the important inspection area in the inspection report. The area 1022 includes an icon 1022a indicating the area corresponding to the standard inspection area in the inspection report. The area 1023 includes an icon 1023a indicating the area corresponding to the inspection-excluded area in the inspection report. The area 1024 includes an icon 1024a indicating the area corresponding to the character string inspection area in the inspection report. The area 1025 includes an icon 1025a indicating the area corresponding to the barcode inspection area in the inspection report.

The icon 1024a and the icon 1025a may be the same icon. In this case, it can be seen that the area indicated by the icon in the inspection report is the area corresponding to at least the data inspection area.

For example, the display is produced so that the color of the icon 531a (see FIG. 5) and the color of the icon 1201a correspond to each other, the type of the icon 532a (see FIG. 5) and the type of the icon 1022a correspond to each other, and the type of the icon 533a (see FIG. 5) and the type of the icon 1023a correspond to each other. The display is produced so that the type of the icon 542a (see FIG. 5) and the type of the icon 1024a correspond to each other and the type of the icon 542d (see FIG. 5) and the type of the icon 1025a correspond to each other.

In a case where the area corresponding to the character string inspection area and the barcode inspection are each indicated in the same manner, for data inspection, the icon 1024a and the icon 1025a are displayed by the same icon. Further, the RGB signal value indicating each of the above-described icons 1021a to 1025a may be displayed along with each of the icons 1021a to 1025a.

In the second item 1020, the items designated among the checkboxes 623a to 623c (see FIG. 6) are displayed. The item not designated among the checkboxes 623a to 623c is excluded from the second item 1020 and the item under the excluded item is moved upward and displayed.

In the third item 1030, the summary of the inspection results, such as inspection start date and time and inspection end date and time, the total number of pages of the inspected printed material, the number of printed materials determined to have no abnormality, and the number of printed materials determined to have an abnormality, is displayed. Then, the items designated in the checkboxes 624a to 624f (see FIG. 6) are displayed in the third item 1030. The item not designated in the checkboxes 624a to 624f is excluded from the third item 1030 and the item under the excluded item is moved upward and displayed.

In the fourth item 1040, information relating to the detailed breakdown relating to the abnormality is displayed in the inspection results. The detailed breakdown relating to the abnormality includes the type of abnormality having occurred on the obverse side or reverse side of the printed material, the number of abnormalities, the number of abnormalities having occurred in the character string inspection and the barcode inspection, the number of pages determined to be a mismatch with the reference image in the collation inspection, the number of other abnormalities and the like. The example in FIG. 10 shows that one spot-shaped defect and one streak are determined to have occurred respectively on the obverse side of the printed material, there exists one page determined to be a mismatch with the reference image, and abnormalities other than the above are determined not to have occurred.

The fourth item 1040 is displayed in a case where the checkbox 624f is displayed. On the other hand, in a case where the checkbox 624f is not designated, the fourth item 1040 is not displayed. Not limited to the above-described example, in a case where there is information that can be display relating to the basic information, the information relating to the inspection setting, and summary relating to the inspection results, it may be displayed.

### <Inspection Report (Details)>

FIG. 11 is a diagram showing one example of the second portion 1100 functioning as “inspection report (details).”

As shown in FIG. 11, the second portion 1100 displays details of the inspection results of the printed material determined to have no abnormality and details of the inspection results of the printed material determined to have an abnormality. For example, the second portion 1100 is displayed in a case where both the checkboxes 625a and 625b (see FIG. 6) are designated.

In the second portion 1100, for each inspected printed material (specifically, for each sheet), No. of the number of copies, sheet No., inspection results, and details of the abnormality are displayed. In the present embodiment, “No. of the number of copies” means the number of copies for which printing and inspection have been performed and “sheet No.” means the number of sheets for which printing and inspection have been performed. As regards “inspection results,” in a case where an abnormality is determined to exist in one of the items for which inspection is being made, “NG” is displayed and in a case where no abnormality is determined to exist in any item, “OK” is displayed.

As shown in FIG. 11, the inspection results of the printed material determined to have an abnormality may be displayed so that it is made easier to recognize that there is an abnormality by changing the background color, heightening the frame, thickening the characters and so on.

### <Inspection Report (Image)>

FIG. 12A is a diagram showing one example of the third portion 1210 functioning as “inspection report (image)” of the printed material determined to have no abnormality.

The third portion 1210 is a superimposed image in which the frame indicating the position of the inspection area is displayed in a superimposition manner on the scanned image of the printed material having actually been inspected and not the reference image displayed in the page preview 510 (see FIG. 5). For example, in a case where the checkbox 626a, the checkbox 626b, and the checkbox 627a are designated, these settings are reflected in the third portion 1210.

As shown in FIG. 12A, in the third portion 1210, the setting of the inspection report performed by a user is reflected and the frame indicating the position of the inspection area is displayed in a superimposition manner on the scanned image of the printed material. In the example in FIG. 12A, an important inspection area 1211 is displayed so as to correspond to the area 511 (see FIG. 5) of the reference image designated as the important inspection area by a user.

Specifically, the color of the frame of the important inspection area 1211 is displayed by the same color as that of the frame of the area 511. In the third portion 1210, a standard inspection area 1212 is displayed so as to correspond to the area 512 (see FIG. 5) of the reference image designated as the standard inspection area by a user. In the example in FIG. 12A, the hatching of the frame of the standard inspection area 1212 is displayed by the same hatching as that of the frame of the area 512. In the third portion 1210, a character string inspection area 1213 is displayed so as to correspond to the area 513 (see FIG. 5) designated as the character string inspection area by a user.

In the example in FIG. 12A, the hatching of the frame of the character string inspection area 1213 is displayed by the same hatching as that of the frame of the area 513. In the third portion 1210, a barcode inspection area 1214 is displayed so as to correspond to the area 514 (see FIG. 5) designated as the barcode inspection area by a user. In the example in FIG. 12A, the hatching of the frame of the barcode inspection area 1214 is displayed by the same hatching as that of the frame of the area 514.

Further, in the example in FIG. 12A, an abnormality is not determined to exist, and therefore, the inspection level set for the inspection area, the name of the abnormality and the like are not displayed. By checking the third portion 1210, it is made possible to check the inspection results of the printed material, the scanned image of the printed material determined to have no abnormality, and the position of the inspection area set for the printed material. Further, depending on the setting of the inspection report, it is also possible to check its type of inspection area.

In the third portion 1210, the inspection level of the inspection area may be displayed. According to the configuration such as this, it is possible to check that no abnormality is detected even in a case where inspection is made with the inspection level.

FIG. 12B is a diagram showing one example of the third portion 1220 functioning as “inspection report (image)” in a case where a streak is detected in the important inspection area.

The third portion 1220 is a superimposed image in which inspection results and the like are displayed in a superimposition manner on the scanned image of the printed material having actually been inspected and not a superimposed image in which inspection results and the like are displayed in a superimposition manner on the reference image displayed in the page preview 510 (see FIG. 5). In a case where the checkbox 626b, the checkbox 627a, the checkbox 627b, the checkbox 627c, and the checkbox 627d in FIG. 6 are designated, in the third portion 1220, these settings are reflected.

As shown in FIG. 12B, in the third portion 1220, the setting of the inspection report performed by a user is reflected and the frame indicating the position and type of inspection area and the inspection level set for the inspection area are displayed in a superimposition manner along with the scanned image of the printed material. In the example in FIG. 12B, each of an important inspection area 1221, a standard inspection area 1222, a character string inspection area 1223, and a barcode inspection area 1224 is displayed so as to correspond to the area 511, the area 512, the area 513, and the area 514 respectively in FIG. 5.

Further, in the example in FIG. 12B, a streak is determined to have been detected in the important inspection area 1221, and therefore, information relating to the streak having occurred in the important inspection area 1221 is displayed. A comment 1225 displayed in a superimposition manner on the scanned image of the printed material determined to have an abnormality is a character string that is displayed in a case where the checkbox 627d is designated. The comment 1225 includes No. of the number of copies, sheet No., the type of inspection area, the inspection level of the inspection area, on which of the obverse side and the reverse side the abnormality has occurred, the type of detected abnormality, the specific position at which the abnormality has occurred and the like. As the specific position at which the abnormality has occurred, it is also possible to display the position in the direction toward the depth (in the depth direction in FIG. 12B) from the surface of the printed material.

Further, in a case where the checkbox 627g is designated, it is possible to more highlight an abnormality occurrence area 1226 in the vicinity of the position at which the abnormality has occurred as a center than the area in which no abnormality has occurred. The abnormality occurrence area 1226 is the area that causes an abnormality to be determined to have occurred and is colored. By the abnormality occurrence area 1226 being highlighted, it is made easier to recognize the position at which the abnormality has occurred.

In a case where the area in which an abnormality has occurred in the operation environment of the inspection application is checked, the abnormality occurrence area 1226 may be displayed by the same display method as the display method by which the area is displayed. Due to that, even in a case where an inspection report is checked in the environment without an inspection application, it is made possible to check an inspection report as in the environment with an inspection application.

Further, in a case where an inspection report is displayed in the PDF format, the comment 1225 may be configured so as to be capable of being switched between display and non-display within the application displaying the third portion 1220. For example, the comment 1225 may be inserted into the third portion 1220 like the annotation function, instead of being coupled therewith.

Due to this, it is made possible to check the reason and the like of the determination of the presence of an abnormality as well as the position of the inspection area in the printed material determined to have an abnormality and the likelihood of the inspection level set for the inspection area.

FIG. 12C is a diagram showing one example of a third portion 1230 functioning as “inspection report (image)” in a case where a spot-shaped defect is detected in the standard inspection area.

The third portion 1230 is a superimposed image in which inspection results and the like are displayed in a superimposition manner on the scanned image of the printed material actually inspected and is not a superimposed image in which inspection results and the like are displayed in a superimposition manner on the reference image displayed in the page preview 510 (see FIG. 5). In a case where the checkbox 626b, the checkbox 627a, the checkbox 627b, the checkbox 627c, and the checkbox 627d in FIG. 6 are designated, in the third portion 1230, these settings are reflected.

As shown in FIG. 12C, in the third portion 1230, the setting of an inspection report performed by a user is reflected and the frame indicating the position and type of the inspection area and the inspection level set for the inspection area as well as the scanned image of the printed material are displayed in a superimposition manner. In the example in FIG. 12C, each of an important inspection area 1231, a standard inspection area 1232, a character string inspection area 1233, and a barcode inspection area 1234 are displayed so as to correspond to the area 511, the area 512, the area 513, and the area 514 in FIG. 5, respectively.

Further, in the example in FIG. 12C, a spot-shaped defect is determined to have been detected in the standard inspection area 1232, and therefore, information relating to the spot-shaped defect having occurred in the standard inspection area 1232 is displayed. A comment 1235 that is displayed in a superimposition manner on the scanned image of the printed material determined to have an abnormality is a character string that is displayed in a case where the checkbox 627d is designated. The comment 1235 includes No. of the number of copies, sheet No., the type of inspection area, the inspection level of the inspection area, on which of the obverse side and the reverse side the abnormality has occurred, the type of detected abnormality, the specific position at which the abnormality has occurred and the like. As the specific position at which the abnormality has occurred, it is also possible to display the position in the direction toward the depth (in the depth direction in FIG. 12C) from the surface of the printed material.

Further, in a case where the checkbox 627g is designated, it is possible to more highlight an abnormality occurrence area 1236 in the vicinity of the position at which the abnormality has occurred as a center than the area in which no abnormality has occurred. The abnormality occurrence area 1236 is the area that causes an abnormality to be determined to have occurred and is colored. By the abnormality occurrence area 1236 being highlighted, it is made easier to recognize the position at which the abnormality has occurred.

In a case where the area in which an abnormality has occurred in the operation environment of the inspection application is checked, the abnormality occurrence area 1236 may be displayed by the same display method as the display method by which the area is displayed. Due to that, even in a case where an inspection report is checked in the environment without an inspection application, it is made possible to check an inspection report as in the environment with an inspection application.

Further, in a case where an inspection report is displayed in the PDF format, the comment 1235 may be configured so as to be capable of being switched between display and non-display within the application displaying the third portion 1230. For example, the comment 1235 may be inserted into the third portion 1230 like the annotation function, instead of being coupled therewith.

Due to this, it is made possible to check the reason and the like of the determination of the presence of an abnormality as well as the position of the inspection area in the printed material determined to have an abnormality and the likelihood of the inspection level set for the inspection area.

FIG. 12D is a diagram showing one example of a third portion 1240 functioning as “inspection report (image)” in a case where a collation mismatch is detected in the character string inspection area.

The third portion 1240 is a superimposed image in which inspection results and the like are displayed in a superimposition manner on the scanned image of the printed material actually inspected, and not a superimposed image in which inspection results and the like are displayed in a superimposition manner on the reference image displayed in the page preview 510 (see FIG. 5). In a case where the checkbox 626a, the checkbox 627a, the checkbox 627d, the checkbox 627e, and the checkbox 627f in FIG. 6 are designated, in the third portion 1240, these settings are reflected.

As shown in FIG. 12D, in the third portion 1240, the setting of the inspection report made by a user is reflected and the frame indicating the position of the inspection area is displayed on the scanned image of the printed material in a superimposition manner. In the example in FIG. 12D, each of an important inspection area 1241, a standard inspection area 1242, a character string inspection area 1243, and a barcode inspection area 1244 is displayed so as to correspond to the area 511, the area 512, the area 513, and the area 514 in FIG. 5, respectively.

Further, in the example in FIG. 12D, a collation mismatch is determined to have been detected in the character string inspection area 1243, and therefore, information relating to the results of the character string inspection performed for the character string inspection area 1243 is displayed. A comment 1245 displayed in a superimposition manner on the scanned image of the printed material determined to have an abnormality is a character string that is displayed in a case where the checkbox 627d is designated. The comment 1245 includes No. of the number of copies, sheet No., the type of inspection area, reading results of characters, character string of collation inspection (character string that should be read originally) and the like. Due to this, it is made possible to check the reason of collation mismatch.

Further, in a case where the checkbox 627g is designated and character string inspection is made, it is also possible to more highlight an abnormality occurrence area 1246 in which the collation mismatch has occurred than the area in which no abnormality has occurred. The abnormality occurrence area 1246 is the area that is the cause of the determination that an abnormality has occurred and is colored. By the abnormality occurrence area 1246 being highlighted, it is made easier to recognize the position at which the abnormality has occurred.

In a case where the area in which an abnormality has occurred in the operating environment of the inspection application is checked, the abnormality occurrence area 1246 may be displayed by the same method of displaying the area. Due to that, even in a case where the inspection report is checked in the environment without the inspection application, it is made possible to check the inspection report as in the case where the inspection application exists. For example, the comment 1245 may be inserted into the third portion 1240 in place of being coupled thereto like the annotation function.

Due to this, it is made possible to check the position of the inspection area in the printed material determined to have an abnormality, the character reading results, the correct character string that should be read originally, and the like.

In “inspection report (image),” not only the scanned image of the printed material, which is the target of inspection, but also information other than that in the above-described example may be displayed in a superimposition manner. Further, each of the comments 1225, 1235, and 1245 described above, the character string relating to the abnormality having occurred is displayed, but a symbol other than the character string may be displayed. For example, the reading results of the comment 1245 may be displayed as “reading results: -”.

In FIG. 12A to FIG. 12D, the example in which the inspection report is displayed in the PDF format is shown, but the case where the inspection report is displayed in the HTML format is also the same as the case where the inspection report is displayed in the PDF format. For example, it may also be possible to design a configuration so that the comment can be switched between display and non-display by performing the link setting for the abnormality occurrence area in a case where the inspection report is displayed in the HTML format.

<Inspection Report that is Displayed in the CSV Format>

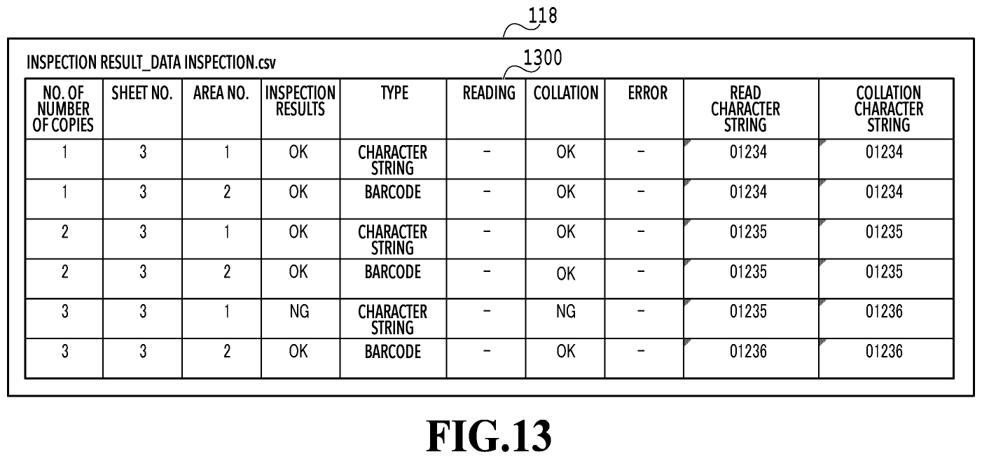

FIG. 13 is a diagram showing one example of a table 1300 that is displayed in a case where an inspection report is created in the CSV format in the present embodiment. In a case where an inspection report is displayed in the CSV format, “inspection report (summary)” and “inspection report (details)” may be displayed delimited as in FIG. 10 and FIG. 11. The item that is difficult to display in the CSV format may not be displayed. For example, in a case where an inspection report is displayed in the CSV format, the printing results of the printed material determined to have an abnormality may not be highlighted (for example, colored and the like). Further, in a case where an inspection report is displayed in the CSV format, “inspection report (image)” is not created.

As shown in FIG. 13, the table 1300 is displayed in the CSV format. The table 1300 includes data output in relation to data inspection results. In a case where an inspection report is displayed in the CSV format, the results of an inspection for one area set as a data inspection target are displayed on each line. Thus, the results of an inspection for sheets for which no data inspection area is set are not displayed.

In the present embodiment, for each data inspection area, No. of the number of copies, sheet No., area No., inspection results, the type of inspection, reading results, collation results, the presence or absence of an error, a character string actually read, and a collation inspection character string (a correct character string that should have been read originally) are displayed.

The method for displaying the inspection results relating to data inspection, setting information, and the like is not limited to the example shown in FIG. 13. For example, the inspection results relating to data inspection, setting information, and the like may be displayed together on each sheet, rather than being written for each data inspection area. For example, the area No., inspection results, type of inspection, reading results, collation results, presence or absence of errors, read character string, and collation inspection character string may be displayed repeatedly for each data inspection area.

As described above, in a case where an inspection report is created in the page layout file format, the inspection PC 110 functioning as the information processing apparatus according to the present embodiment creates a composite image displaying the inspection level of an inspection area together with a scanned image of printed material.

Therefore, the information processing apparatus according to the present embodiment is capable of checking inspected printed material and the inspection level thereof.

Further, the information processing apparatus according to the present embodiment creates an inspection report including the above composite image in a general file format. This makes it possible to easily check the inspection report without using an application dedicated to printed material inspection. For example, transmitting the inspection report created in the page layout file format to a PC on which a general OS is installed makes it possible to check an inspection level together with the scanned image of the printed material even in a location distant from a PC dedicated to inspection.

### Variation of First Embodiment

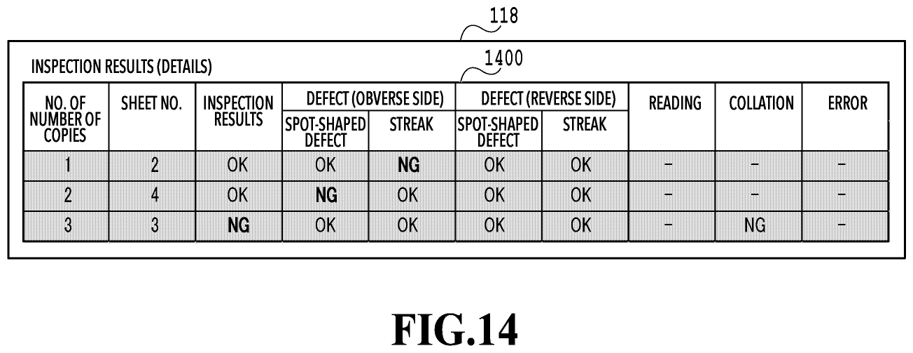

FIG. 14 is a diagram showing a variation of the “inspection report (details)” applicable to the present embodiment. As shown in FIG. 14, a second portion 1400 displays only the details of the inspection results of printed material determined to have an abnormality.

According to this configuration, only the details of the inspection results of the printed material determined to have an abnormality are displayed, so that it is possible to save the trouble of checking the inspection results of printed material determined to have no abnormality. Incidentally, not only the example in FIG. 14, but also any information that can be displayed in relation to the detailed abnormality, inspection results, and inspected printed material, if any, may be displayed.

### Second Embodiment

The present embodiment aims to provide an inspection PC that can check for abnormalities in more detail than in the first embodiment. In the following description, the same reference numeral is used for a constituent similar to or corresponding to that in the first embodiment, descriptions thereof are omitted, and differences are mainly described.

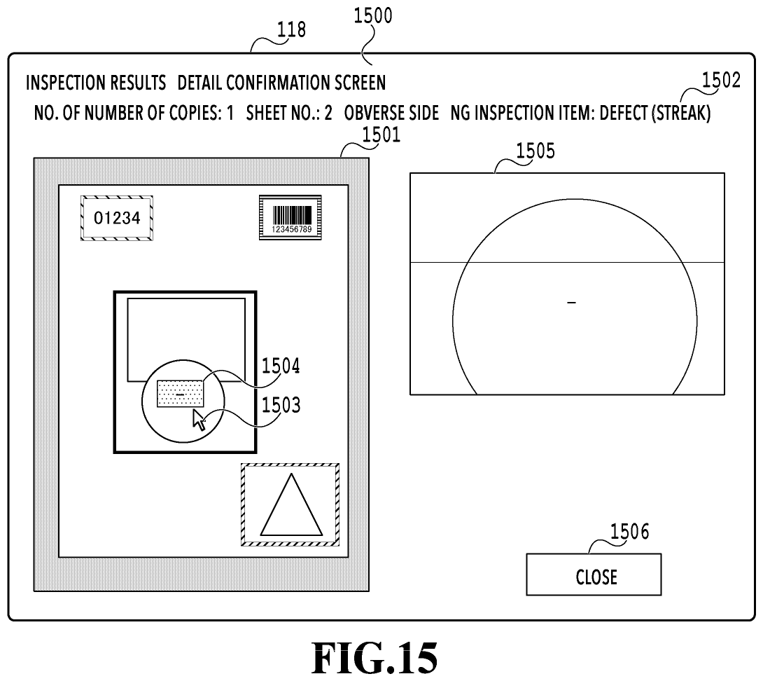

FIG. 15 is a diagram showing an example of an abnormality confirmation screen 1500 that can be displayed on the UI unit 118 of the inspection PC 110 in the present embodiment.

The abnormality confirmation screen 1500 in FIG. 15 is displayed by activating an application dedicated to printed material inspection and installed on the inspection PC 110. The abnormality confirmation screen 1500 is displayed in order to check the scanned image of the printed material determined to have an abnormality and the abnormality that has occurred in a case where the application dedicated to inspection is activated to check inspection results. For example, in a case where the application dedicated to inspection is activated to check the printed material determined to have an abnormality, the abnormality confirmation screen 1500 is displayed on the UI unit 118.

As shown in FIG. 15, the abnormality confirmation screen 1500 includes a page preview 1501 that displays the scanned image read in S706 (see FIG. 7). The abnormality confirmation screen 1500 includes text 1502 that displays detailed information relating to a print job of printed material corresponding to the scanned image displayed in the page preview 1501. The text 1502 in the present embodiment displays No. of the number of copies and sheet No. given to printed material in which a streak has been detected, and the fact that the streak occurs on the obverse side of the printed material. Of course, information that can be displayed in the text 1502 is not limited to these examples. For example, information indicating that a spot-shaped defect has occurred on the reverse side of the printed material may be displayed.

In the present embodiment, a mouse cursor 1503 indicates the position of a mouse operated by a user. An inspection area in printed matter is shown on the abnormality confirmation screen 1500. In the example in FIG. 15, an abnormality occurrence area 1504 is displayed so as to correspond to the abnormality occurrence area 1226 (see FIG. 12B). In this way, coloring the abnormality occurrence area 1504 so as to correspond to the abnormality occurrence area 1326 makes it easier to recognize the position and type of abnormality determined to exist on the printed material while looking at the scanned image of the inspected printed matter. It should be noted that the plurality of inspection areas in the present embodiment are displayed so as to correspond to respective inspection areas in FIG. 12B.

Further, the abnormality confirmation screen 1500 may be configured so that the type of frame indicating an inspection area can be switched depending on the type of detected abnormality. Switching between the types (e.g., colors) of frames indicating inspection areas depending on the type of abnormality makes it possible to easily check the type of detected abnormality.

The abnormality confirmation screen 1500 includes an enlarged display area 1508 in which the detected abnormality is displayed in an enlarged manner. In the enlarged display area 1508, in a case where the mouse cursor 1503 is located within the page preview 1501, a surrounding area centered around a position indicated by the mouse cursor 1503 in a scanned image is displayed in an enlarged manner. For example, putting the mouse cursor 1503 near the abnormality occurrence area 1504 makes it possible to check a more detailed image of an area in which an abnormality has occurred. In the enlarged display area 1508 according to the present embodiment, a streak that has occurred in the abnormality occurrence area 1504 is displayed in an enlarged manner. This allows the details of the streak that has occurred in the abnormality occurrence area 1504 to be checked.

The abnormality confirmation screen 1500 includes a “Close” button 1506 for closing the abnormality confirmation screen 1500. In a case where the “Close” button 1506 is pressed down, the abnormality confirmation screen 1500 is closed.

The inspection PC according to the present embodiment makes it possible to check an enlarged image of an abnormality together with an inspection report by using the inspection application. Thus, the inspection PC according to the present embodiment makes it possible to check an abnormality in more detail than in the first embodiment.

### Other Embodiment

In the first embodiment, the inspection report is made in response to the creation button 303 being pressed down, but may be made continuously after the processing at S711 (see FIG. 7).

The present disclosure can also be implemented by processing in which a program implementing one or more of the functions according to the above embodiments is supplied to a system or apparatus via a network or a storage medium and one or more processors in a computer of the system or apparatus read and execute the program. The present disclosure can also be implemented by a circuit (e.g., an ASIC) for implementing one or more functions.

The information processing apparatus according to the present disclosure is capable of checking inspected printed material and the inspection level thereof.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-015348, filed Feb. 5, 2024 which are hereby incorporated by reference wherein in its entirety.

What is claimed is:

1. An information processing apparatus comprising:
a memory that stores a program; and
a processor that executes the program to perform:
obtaining a scanned image of printed material, an inspection area set for the printed material, and an inspection level in the inspection area; and
outputting a result of an inspection for the printed material along with the scanned image, the inspection area, and the inspection level.

2. The information processing apparatus according to claim 1, wherein
the processor executes the program to perform:
generating the composite image obtained by superimposing the inspection area and the inspection level on the scanned image, and
outputting the composite image.

3. The information processing apparatus according to claim 2, wherein
the processor executes the program to perform:
generating the composite image in a page layout file format.

4. The information processing apparatus according to claim 3, wherein
the processor executes the program to perform:
generating the composite image in a PDF format or in an HTML format.

5. The information processing apparatus according to claim 3, wherein
the processor executes the program to perform:
creating an inspection report including the composite image generated in the page layout file format for each print job.

6. The information processing apparatus according to claim 5, wherein
the processor executes the program to perform:
creating the inspection report by dividing the inspection report into groups of a designated number of sheets.

7. The information processing apparatus according to claim 2, wherein
the processor executes the program to perform:
generating the composite image displaying the inspection area without displaying the inspection level, in a case where it is determined that there is no abnormality in the printed material.

8. The information processing apparatus according to claim 7, wherein
the processor executes the program to perform:
outputting the composite image for each designated number of sheets.

9. The information processing apparatus according to claim 1, wherein
the processor executes the program to perform:
setting the inspection area and the inspection level.

10. The information processing apparatus according to claim 9, wherein
the processor executes the program to perform:
designating a standard inspection area for detecting an abnormality of a predetermined size and an important inspection area for detecting an abnormality whose size is smaller than a size of an abnormality that is detected inside the standard inspection area.

11. The information processing apparatus according to claim 9, wherein
the processor executes the program to perform:
designating the inspection level that includes a plurality of steps such that a smaller size of an abnormality can be detected as a value of a step increases.

12. The information processing apparatus according to claim 11, wherein
the processor executes the program to perform:
designating the inspection level depending on a type of abnormality, in a case where a plurality of types of abnormalities are detected inside the one inspection area.

13. The information processing apparatus according to claim 5, wherein
the processor executes the program to perform:
transmitting the inspection report to an external device.

14. The information processing apparatus according to claim 1, wherein
the processor executes the program to perform:
displaying the inspection area in an enlarged manner.

15. The information processing apparatus according to claim 2, wherein
the processor executes the program to perform:
generating the composite image displaying a type of abnormality having occurred.

16. The information processing apparatus according to claim 2, wherein
the processor executes the program to perform:
generating the composite image displaying a position of the abnormality having occurred in the inspection area.

17. The information processing apparatus according to claim 2, wherein
the processor executes the program to perform:
generating the composite image also displaying information indicating a type of the inspection area.

18. The information processing apparatus according to claim 17, wherein
the processor executes the program to perform:
generating the composite image displaying a color and hatching of a frame indicating the inspection area according to a type of inspection and both of the color and the hatching, in a case where there are a plurality of types of inspections made for the printed material.

19. The information processing apparatus according to claim 1, wherein
the processor executes the program to perform:
changing a destination to which the printed material is discharged depending on an inspection result.

20. The information processing apparatus according to claim 19, wherein
the processor executes the program to perform:
determining to discharge the printed material to a first discharge destination, in a case where the size of the abnormality having occurred in the printed material is greater than or equal to the predefined value; and
determining to discharge the printed material to a second discharge destination different from the first discharge destination, in a case where the size of the abnormality having occurred in the printed material is greater than or equal to the predefined value.

21. An information processing system comprising:
an information processing apparatus comprising: an obtaining unit configured to obtain a scanned image of printed material, an inspection area set for the printed material, and an inspection level in the inspection area; and an output unit configured to output a result of an inspection for the printed material along with the scanned image, the inspection area, and the inspection level; and
an image forming apparatus configured to form an image on a sheet using a color material.

22. The information processing system according to claim 21, wherein
the image forming apparatus further comprises:
a first discharge unit to which printed material determined to have no abnormality is discharged; and
a second discharge unit which is different from the first discharge unit and to which printed material determined to have an abnormality is discharged.

23. An information processing method comprising:
obtaining a scanned image of printed material, an inspection area set for the printed material, and an inspection level in the inspection area; and
outputting a result of an inspection for the printed material along with the scanned image, the inspection area, and the inspection level.
